(19) United States
(12) Patent Application Publication
(10) Pub. No.: US 2026/0034736 A1
(43) Pub. Date: Feb. 5, 2026

(54) Topology-Based Additive Manufacturing of Structures through Use of Printing-Induced Strength Anisotropy

(71) Applicant: The Board of Trustees of the University of Illinois, Urbana, IL (US)

(72) Inventors: Xiaojia Zhang, Urbana, IL (US); Rahul Dev Kundu, Urbana, IL (US)

(21) Appl. No.: 19/285,329

(22) Filed: Jul. 30, 2025

Related U.S. Application Data
(60) Provisional application No. 63/678,616, filed on Aug. 2, 2024.

(51) Int. Cl. B29C 64/386; B22F 10/80; B33Y 50/00

(52) U.S. Cl. CPC B29C 64/386; B22F 10/80; B33Y 50/00

(57) ABSTRACT

An example embodiment includes: obtaining a first relation between a global stiffness matrix, a global displacement vector, and external forces applied to a physical structure comprising one or more types of materials; determining a second relation between structural geometry of the physical structure, anisotropic and isotropic material phases in the physical structure, a stiffness of the physical structure, and a plurality of densities and volumes for each of the material phases; providing, to an optimization solver application, the first relation, the second relation, and instructions to determine values of the structural geometry and the anisotropic and isotropic material phases that simultaneously maximize the stiffness and minimize the volumes while maintaining the levels of stress tolerance in presence of the external forces; and receiving, from the optimization solver application, the values of the structural geometry and the anisotropic and isotropic material phases.

### CROSS-REFERENCE TO RELATED APPLICATION

This application claims priority to U.S. provisional patent application No. 63/678,616, filed Aug. 2, 2024, which is hereby incorporated by reference in its entirety.

### GOVERNMENT LICENSE RIGHTS

This invention was made with government support under contracts 2047692 and 2127134 awarded by the National Science Foundation. The government has certain rights in the invention.

### BACKGROUND

Advanced material printing techniques, such as additive manufacturing (commonly known as 3D printing), promise to improve industrial processes with their flexibility, customizability, material efficiency, and rapid prototyping, among other advantages. Nonetheless, current techniques for stiff and strong additive manufacturing require extensive printing path control to prevent printing overlap in regions with stress concentrations, do not employ sufficient anisotropic strength criteria to prevent high stress concentration-induced material failure for a prescribed load, and/or cannot achieve build-direction or topology goals simultaneously with other design goals. These approaches can also result in increased computational complexity, longer design cycles, and greater demand for processing resources, which may limit scalability and practical adoption in high-volume manufacturing environments.

### SUMMARY

The embodiments herein provide technical improvements to these and potentially other technical problems by employing an additive manufacturing methodology that harnesses the anisotropy of 3D-printed materials, especially in extrusion-based additive manufacturing, to manufacture stiff, strong, and lightweight structures for a given design problem. This topology framework simultaneously considers: a) the structural geometry, b) anisotropic (i.e., orthotropic) and isotropic material phase distributions within the structure, and c) the anisotropy orientations (i.e., stiffest and strongest directions) within the anisotropic material phases, to achieve a stiff, strong, and lightweight design using a novel anisotropic strength-based multi-material formulation. The associated additive manufacturing method can realize the topology-optimized design with optimized geometry, infill print paths, and strong s-shaped interfaces between the different material phases. Experimental investigations show up to 37% improved stiffness and 100% improved strength per mass for the optimized and fabricated structures.

The embodiments herein address a number of limitations of conventional additive manufacturing methods for stiff/strong structures. One is simultaneous consideration (e.g., optimization) of geometry and the infill printing path for strength. The embodiments simultaneously harness two different mechanisms for enhanced structural stiffness and strength. They also reduce local stress concentrations in structures by optimizing geometry. At the same time, they align the infill printing paths along stress paths to provide maximum local stiffness and strength to the printed parts. Conventional approaches typically harness any one of these two mechanisms. Another is the realization of strong interfaces between dissimilar material phases (i.e., infill patterns). Interfaces that are s-shaped provide higher local infill density and multi-axial infill pattern, resulting in strong interfaces (and member joints) that dramatically enhance structural strength compared to conventional infill patterns.

Thus, these embodiments can significantly improve a number of manufacturing procedures. As one example, stress-sensitive components for various mechanical devices can be designed and 3D printed to provide sufficient stiffness and strength with significantly less material usage. In another example, simultaneously optimizing geometry and anisotropy direction (infill printing paths are analogous to fiber direction) can be readily adopted to fabricate strong fiber-reinforced structures for various aerospace applications, for example, carbon fiber reinforced thermoplastic components. In another example, concrete 3D printing is improved as it primarily involves extrusion-based additive manufacturing. In another example, topology optimization-guided additive manufacturing methodology may be streamlined to deliver a direct 3D printable solution that includes improved geometry, infill printing path, and s-shaped interfaces for a given design problem and candidate print material list.

In general, higher anisotropy of printed material results in higher performance improvement from the proposed framework. Hence, any engineering and industrial applications that involve intrinsically anisotropic materials (such as fiber-reinforced composites), and/or 3D printing-induced anisotropic materials (especially from extrusion-based additive manufacturing) may potentially benefit from the embodiments herein.

The disclosed embodiments provide technical improvements to computing systems and additive manufacturing processes by enabling integrated design and manufacturing workflows that concurrently consider structural geometry, material phase distribution, and anisotropy orientation within a unified computational framework. This reduces the need for iterative manual adjustments between separate design and manufacturing stages, thereby decreasing processing time and computational overhead in generating print-ready models. The system's capability to algorithmically determine infill paths aligned with principal stress directions, and to generate s-shaped interfaces between material phases, enhances the accuracy of build instructions transmitted to 3D printers, resulting in parts with improved mechanical performance while minimizing material usage. These improvements advance the efficiency, reliability, and functional capability of computer-controlled 3D printing systems.

Another type of embodiment involves a multimaterial topology optimization framework for sustainable infrastructure design with substantial mechanical advantages. The framework harnesses the mechanical superiority of steel and the environmentally sustainable properties of biomaterials, such as laminated bamboo and timber, to design stiff, strong, and sustainable structures. The fibrous characteristics of biomaterials are incorporated using the transversely isotropic constitutive relation and Tsai-Wu failure criterion, while steel is assumed isotropic with von Mises yield criterion. Two sustainability-oriented formulations are proposed to accommodate different design scenarios, accounting for performance, environmental impacts, and costs. Both formulations can be used to design steel-biomaterial hybrid structures with significant sustainability improvements over previous techniques. Specifically, biomaterials are predominantly used in low or moderately stressed members, while steel is optimally utilized in high-stressed or primary load-bearing members. The proposed framework presents a rational design paradigm for high-performance and sustainable multimaterial engineering structures that can benefit construction industries from environmental perspectives.

A system of one or more computers or computing systems can be configured to perform particular operations or actions by virtue of having software, firmware, hardware, or a combination thereof installed that in operation causes or cause the computer(s) or systems(s) to perform the actions. One or more computer programs can be configured to perform particular operations or actions by virtue of including instructions that, when executed by data processing apparatus, cause the apparatus to perform the actions.

One general aspect involves a method. The method includes: obtaining a first relation between a global stiffness matrix, a global displacement vector, and external forces applied to a physical structure may include one or more types of materials. The method also includes determining a second relation between structural geometry of the physical structure, anisotropic and isotropic material phases in the physical structure, a stiffness of the physical structure, and a plurality of densities and volumes for each of the material phases, where the second relation is subject to levels of stress tolerance at points within the physical structure. The method also includes providing, to an optimization solver application, the first relation, the second relation, and instructions to determine values of the structural geometry and the anisotropic and isotropic material phases that simultaneously maximize the stiffness and minimize the volumes while maintaining the levels of stress tolerance in presence of the external forces. The method also includes receiving, from the optimization solver application, the values of the structural geometry and the anisotropic and isotropic material phases. The method also includes providing, to an additive manufacturing system, a digital model of the physical structure including the values of the structural geometry and the anisotropic and isotropic material phases, where the additive manufacturing system is configured to employ process-induced anisotropy to print a physical representation of the physical structure in accordance with the structural geometry and the anisotropic and isotropic material phases.

Another general aspect involves a further method. The further method includes: obtaining a first relation between a global stiffness matrix, a global displacement vector, and external forces applied to a physical structure comprising a combination of material types including a high-carbon material type and low-carbon material type, wherein the high-carbon material type has a greater carbon footprint than the low-carbon material type. The method also includes determining a second relation between density of the physical structure, the material types in the physical structure, a stiffness of the physical structure, a structural compliance of the physical structure, and a cost of the physical structure, where the second relation is subject to levels of stress tolerance at points within the physical structure. The method also includes providing, to an optimization solver application, the first relation, the second relation, and instructions to determine selections of the material types for parts of the physical structure that simultaneously maximize the stiffness and minimize the cost while maintaining the structural compliance in presence of the external forces. The method also includes receiving, from the optimization solver application, the selections of the material types. The method also includes providing, to a manufacturing system, a digital model of the physical structure including the selections of the material types, wherein the manufacturing system is configured to produce at least some of the parts of the physical structure as the high-carbon material type or the low-carbon material type based on the digital model.

Another general aspect involves an additional method. The additional method includes: obtaining a first relation between a global stiffness matrix, a global displacement vector, and external forces applied to a physical structure comprising a combination of material types including a high-carbon material type and low-carbon material type, wherein the high-carbon material type has a greater carbon footprint than the low-carbon material type. The method also includes determining a second relation between density of the physical structure, the material types in the physical structure, a stiffness of the physical structure, an environmental impact of the physical structure, and a cost of the physical structure, where the second relation is subject to levels of stress tolerance at points within the physical structure. The method also includes providing, to an optimization solver application, the first relation, the second relation, and instructions to determine selections of the material types for parts of the physical structure that simultaneously minimize the cost and the environmental impact while maintaining the stiffness to at least a baseline level. The method also includes receiving, from the optimization solver application, the selections of the material types. The method also includes providing, to a manufacturing system, a digital model of the physical structure including the selections of the material types, wherein the manufacturing system is configured to produce at least some of the parts of the physical structure as the high-carbon material type and the low-carbon material type based on the digital model.

Other embodiments include corresponding computer system(s), apparatus(es), and computer program(s) recorded on one or more computer storage devices, each configured to perform the actions of the methods.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts fabrication of anisotropic and isotropic parts, in accordance with example embodiments.

FIG. 4A depicts print parameters for additive manufacturing, in accordance with example embodiments.

FIG. 4B depicts longitudinal stiffness and strength of anisotropic infill densities, in accordance with example embodiments.

FIG. 5 depicts interface fabrication and strength tests, in accordance with example embodiments.

FIG. 6 depicts stiffness and strength parameters for anisotropic and isotropic material phases, in accordance with example embodiments.

FIG. 7 depicts experimentally estimated stiffness and strength parameters, in accordance with example embodiments.

FIG. 8 depicts local failure prevention with anisotropic stress constraints, in accordance with example embodiments.

FIG. 9 depicts experimental evaluation of optimized designs, in accordance with example embodiments.

FIG. 10 depicts mechanical performances of designs with same topology and different infill patterns, in accordance with example embodiments.

FIG. 11 depicts topology optimization with tension and compression loading for asymmetric tension-compression strength, in accordance with example embodiments.

FIG. 12 depicts experimental evaluation of optimized designs, in accordance with example embodiments.

FIG. 13 is a flow chart, in accordance with example embodiments.

FIG. 14 depicts the motivation and potential impact of a multimaterial, multi-objective topology optimization for sustainable structure design, in accordance with example embodiments.

FIG. 15 depicts stiffness parameters, in accordance with example embodiments.

FIG. 16 depicts strength parameters, in accordance with example embodiments.

FIG. 17 depicts cost and environmental parameters, in accordance with example embodiments.

FIG. 18 depicts performance measures and numerical examples, in accordance with example embodiments.

FIG. 19 depicts incorporating strength and environmental impact in topology optimization, in accordance with example embodiments.

FIG. 20 depicts a comparison of designs, in accordance with example embodiments.

FIG. 21 depicts optimization with different cost and environmental impact objectives, in accordance with example embodiments.

FIG. 22 depicts a comparison of designs, in accordance with example embodiments.

FIG. 23 depicts optimization with different stiffness and strength requirements, in accordance with example embodiments.

FIG. 24 depicts comparisons of towers optimized with steel and bamboo, in accordance with example embodiments.

FIG. 25 depicts a comparison of designs, in accordance with example embodiments.

FIG. 26 is a flow chart, in accordance with example embodiments.

FIG. 27 is a flow chart, in accordance with example embodiments.

### DETAILED DESCRIPTION

Example methods, devices, and systems are described herein. The words “example” and “exemplary” are used to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. The aspects of the present disclosure can be arranged, substituted, combined, separated, and designed in a wide variety of different configurations. For example, the separation of software features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Unless clearly indicated otherwise herein, the term “or” is to be interpreted as the inclusive disjunction. For example, the phrase “A, B, or C” is true if any one or more of the arguments A, B, C are true, and is only false if all of A, B, and C are false.

Herein, a “software application” may be any structured set of computer-executable instructions that can perform a specific function or a set of related functions. This encompasses programs that operate in various computing environments, including but not limited to standalone desktop applications, mobile applications, web-based applications, embedded systems software, cloud-based services, distributed computing applications, and operating systems. Software applications may involve the processing, manipulation, and management of data, control of hardware devices, execution of various algorithms, provisioning of user interfaces for interaction, and communication with other software applications or services. The term is inclusive of software that performs an array of functions, whether pre-installed, downloaded, accessed remotely, or delivered as a service. This definition is intended to cover a broad range of software implementations, architectures, and platforms, recognizing the evolving nature of technology and software development practices.

Furthermore, herein the terms “optimize,” “maximize,” “minimize,” and any related expressions are not to be construed as indicating that the disclosed embodiments necessarily achieve the absolute best possible outcomes according to these criteria. Instead, these terms should be interpreted as representing objectives or goals that the embodiments aim to achieve to varying degrees under certain conditions. The use of such terms is intended to describe general intents or directions, rather than a definitive statement of performance.

Moreover, the effectiveness and efficiency of the embodiments herein may vary based on a multitude of factors, including but not limited to the specific application, operating environment, and the precise configuration thereof. As such, while the embodiments may strive to optimize, maximize, or minimize certain parameters in certain scenarios, it is not guaranteed that the results will always represent the highest degree of optimization, maximization, or minimization possible. Instead, these terms should be understood as conveying the intent to improve or enhance certain aspects relative to a baseline or comparative state.

Therefore, the scope of these embodiments should not be limited or interpreted to imply that they always deliver the optimal, maximal, or minimal outcomes. Rather, the embodiments are intended to offer improvements or enhancements in alignment with the stated objectives, recognizing that such improvements may be context-dependent and subject to practical limitations. The discussion herein should be understood and interpreted with this perspective in mind, so that this broad and flexible nature is appropriately appreciated.

Herein variables representing vector, matrix, and tensor values are not given any special designation (such as bold text). Instead, such variables can be differentiated from scalar values based on context and the understanding of one of ordinary skill in the art.

The following documents are incorporated by reference herein in their entireties: Kundu, R.D., Zhang, X.S. Sustainability-oriented multimaterial topology optimization: designing efficient structures incorporating environmental effects. Struct Multidisc Optim. 68, 17 (2025). doi.org/10.1007/s00158-024-03930-8; Kundu, R.D., Zhang, X.S. Additive manufacturing of stiff and strong structures by leveraging printing-induced strength anisotropy in topology optimization. Additive Manufacturing, Volume 75, 2023, doi.org/10.1016/j.addma.2023.103730; Kundu, R.D., Zhang, X.S. Stress-based topology optimization for fiber composites with improved stiffness and strength: Integrating anisotropic and isotropic materials. Composite Structures, Volume 320, 2023, doi.org/10.1016/j.compstruct.2023.117041.

### I. Example Computing Devices and Cloud-Based Computing Environments

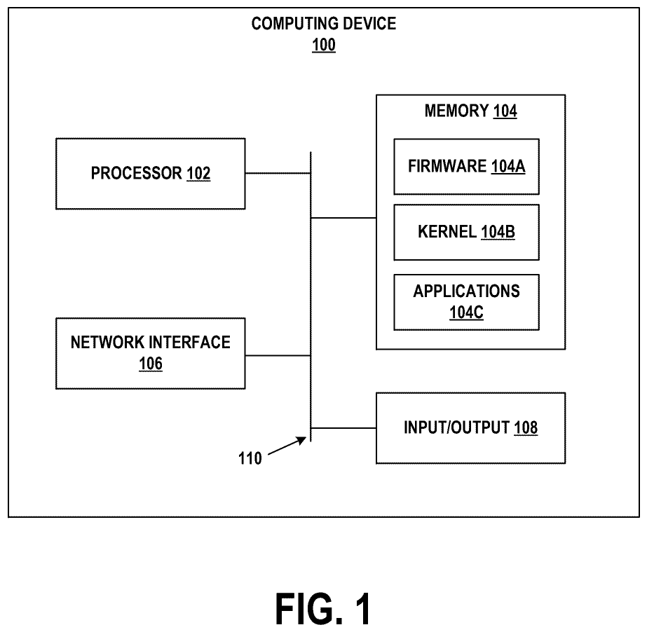

FIG. 1 is a simplified block diagram of an example computing device 100, illustrating some of the components that could be included in a computing device configured to operate in accordance with the embodiments herein. Computing device 100 may be a client device (e.g., a device actively operated by a user), a server device (e.g., a device that provides computational services to client devices), or some other type of computational platform. Some server devices may operate as client devices from time to time to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, video screens, and so on).

Processor 102 may be one or more of any type of computer processing element, such as a central processing unit (CPU), graphical processing unit (GPU), digital signal processor (DSP), network processor, encryption processor, and/or other integrated circuit or controller capable of performing processor operations. In some embodiments, processor 102 may comprise one or more single-core or multi-core processors, with each core representing an independent processing unit. Processor 102 may also include register memory for temporarily storing instructions and related data, and cache memory for temporarily storing recently used instructions and data.

GPUs may include specialized circuitry designed to perform rapid mathematical calculations for rendering graphics, processing large datasets, and supporting machine learning. A GPU may include a large number of small processing cores that operate in parallel, facilitating the decomposition of tasks into smaller units that can be processed concurrently. This parallelism may allow GPUs to outperform traditional CPUs for certain classes of computational tasks (though CPUs may also support forms of parallelism at the core or instruction level).

Memory 104 may include any form of computer-usable memory, including but not limited to random access memory (RAM), read-only memory (ROM), and non-volatile memory such as hard disk drives, solid state drives, compact discs (CDs), digital video discs (DVDs), and/or magnetic tape storage. Memory 104 may therefore include both volatile and non-volatile memory components. Any non-volatile memory may also be referred to as persistent storage. Memory 104 may store program instructions and/or data on which the program instructions operate. For example, memory 104 may store instructions on a non-transitory, computer-readable medium, where the instructions are executable by processor 102 to perform any of the methods or operations described herein.

As shown in FIG. 1, memory 104 may include firmware 104A, kernel 104B, and/or applications 104C. Firmware 104A may comprise program code used to initialize computing device 100. Kernel 104B may include an operating system with modules for memory management, process scheduling, input/output handling, and device communication. Kernel 104B may also include device drivers that enable the operating system to interface with hardware components. Applications 104C may include user-space software such as web browsers, email clients, web servers, and/or software libraries.

Network interface 106 may include one or more wireline interfaces, such as Ethernet (e.g., Gigabit Ethernet, 10 Gigabit Ethernet, Ethernet over fiber). Network interface 106 may also support one or more non-Ethernet communication media, including wireless protocols such as Wi-Fi (e.g., IEEE 802.11), Bluetooth (IEEE 802.15.1), cellular (e.g., 3G, 4G LTE, 5G NR), and Zigbee (IEEE 802.15.4). Other supported interfaces may include Near Field Communication (NFC), infrared (IrDA), Universal Serial Bus (USB)-based network adapters, and/or High-Definition Multimedia Interface (HDMI) connectors. Additional or alternative interfaces may be used.

Input/output unit 108 may facilitate interaction between computing device 100 and peripheral devices or users. The input/output unit may include input devices such as keyboards, mice, and touchscreens, and output devices such as monitors, printers, or light-emitting diodes (LEDs). Computing device 100 may communicate with these types of devices using a port configured to support USB or HDMI for example.

In some embodiments, one or more computing devices such as computing device 100 may be deployed off-premises. The physical location, network configuration, and/or internal topology of these devices may not be apparent to client devices. Accordingly, such devices may be implemented as cloud-based computing platforms residing in one or more data center environments.

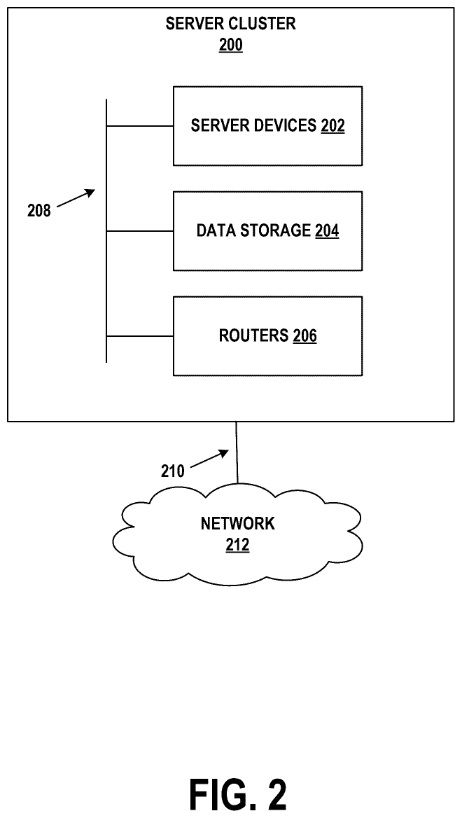

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, instances data storage 204, and routers 206 in server cluster 200 may depend on the computing task(s) and/or applications assigned to server cluster 200.

For example, server devices 202 may be configured to perform various computing tasks of computing device 100. Thus, computing tasks can be distributed among one or more of server devices 202. To the extent that these computing tasks are performed in parallel, such a distribution of tasks may reduce the total time to complete these tasks and return a result. For purposes of simplicity, both server cluster 200 and individual server devices 202 may be referred to as a “server device.” This nomenclature should be interpreted to encompass configurations involving one or more distinct server devices, data storage systems, and cluster-level routing components, and should be interpreted to encompass any such configurations.

Data storage 204 may include data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to mitigate data loss due to drive failures or other system faults. Other types of memory devices, aside from drives, may be used.

Routers 206 may include networking equipment configured to provide internal and external communications for server cluster 200. For example, routers 206 may include one or more network-layer switching or routing components (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database or a No-SQL database (e.g., MongoDB). Various types of data structures may store the information in such a database, including but not limited to files, tables, arrays, lists, trees, and tuples. Furthermore, any databases in data storage 204 may be implemented as monolithic systems or distributed across multiple physical or virtualized storage resources.

Server devices 202 may be configured to transmit data to and receive data from data storage 204. This transmission and retrieval may take the form of SQL queries or other types of database queries, and the output of such queries, respectively. Additional content, such as text, images, video, and/or audio may be included as well. Furthermore, server devices 202 may organize the received data into web pages or web application representations. Such a representation may take the form of a markup language, such as HTML, XML, JSON, or some other standardized or proprietary format. Moreover, server devices 202 may have the capability of executing various types of computerized scripting languages, including but not limited to Perl, Python, PHP Hypertext Preprocessor (PHP), Active Server Pages (ASP), JavaScript, and so on. Computer program code written in these languages may facilitate the provision of web pages to client devices, as well as client device interaction with the web pages. Alternatively or additionally, Java may be used to facilitate the generation of web pages and/or to provide web application functionality with dynamic content handling.

### II. Example Framework for Additive Manufacturing of Stiff and Strong Structures

The embodiments herein demonstrate how material anisotropy induced during additive manufacturing, specifically in material extrusion 3D printing, can be leveraged to design stiff, strong, and lightweight structures by simultaneously optimizing the design geometry and the orientation of in-plane infill directions using an anisotropic strength-based topology optimization framework. The methodology assumes plane stress problems, and incorporates transversely isotropic stiffness and strength to account for in-plane anisotropy from material extrusion paths. First, several stress-sensitive design domains are optimized with a unique strength-based topology optimization that considers both direction-dependent and direction-independent stiffness and strengths of dissimilar candidate material phases. The formulation minimizes the weighted sum of compliance and relative material mass while satisfying Tsai-Wu and von Mises stress constraints for candidate anisotropic and isotropic material phases, respectively, to provide high stiffness and strength per material usage.

Then, the process-induced anisotropy from material extrusion 3D printing can be utilized to fabricate the optimized designs with anisotropic and isotropic parts. Suitable infill density and interface fabrication strategies are adopted to further facilitate the high stiffness-and-strength-to-mass ratios in the fabricated structures. The fabricated structures are experimentally investigated for their stiffness, strength, and material usage to demonstrate the advantages of the proposed design optimization and fabrication methodology. A contribution of this work is an overall methodology to design and manufacture stiff and strong structures with material extrusion additive manufacturing by accounting for printing-induced strength anisotropy, which involves (a) simultaneous optimization of both topology and orthotropy/anisotropy direction with the consideration of printing-induced strength anisotropy, (b) realization and characterization of anisotropic/isotropic infill, (c) proposing a strong, multi-axial interface fabrication suitable for topology optimized anisotropic structures, and (d) experimental evidence of increased stiffness and strength compared to some conventional fabrication approaches.

While these embodiments focus on material extrusion additive manufacturing, the proposed methodology may also be adapted to optimize build directions for other additive manufacturing processes with dominant out-of-plane build anisotropy, such as powder bed fusion, by enabling multicomponent topology optimization and modular fabrication, where longitudinal and transverse directions can be represented by directions along and perpendicular to the print-plane. Therefore, these embodiments are applicable toward the realization and demonstration of stiff, strong, and lightweight structures with optimized use of process-induced anisotropy in additive manufacturing.

This section presents the design formulation and fabrication details, considering anisotropy in stiffness and strength induced by the printing process in material extrusion 3D printing. This section includes a topology formulation (e.g., optimization) framework that generates stiff, strong, and lightweight designs using both anisotropic and isotropic material phases. This section also presents the manufacturing details for anisotropic and isotropic material parts along with their interfaces. This section also presents a summarization of the characterized stiffness and strength properties of the different material phases, which are then used for the design examples.

### A. Design

These embodiments employ an anisotropic strength-based topology optimization framework to generate optimized designs for additive manufacturing that are stiff, strong, and lightweight. The framework uses a multimaterial topology optimization approach, where the candidate material phases include an anisotropic (i.e., transversely isotropic) material phase with different available longitudinal directions and an isotropic material phase. A brief description of the framework is presented below, including (a) the multimaterial design parameterization with anisotropic and isotropic material phases along with their dissimilar stiffness and strength interpolation schemes, and (b) the Augmented-Lagrangian based optimization formulation considering many local anisotropic and isotropic stress constraints.

These techniques use a two-field multimaterial design parameterization scheme, where the design density variable ρ characterizes the structural geometry, and the design material variables ξ^{(k)} where k=1, . . . , N_{ξ} characterize the anisotropic and isotropic material phases in the design. For each element e in a discretized design domain, (a) solid and void regions are characterized by ρ̅ₑ taking values of 1 and 0, respectively, where ρ̅ is the physical density variable obtained using filter and Heaviside projection on ρ, and (b) the presence and absence of material phase i is characterized by

$${\overline{m}}_{e}^{( i )}$$

taking values 1 and 0, respectively. Here, m̅⁽ⁱ⁾ with i=1, . . . , Nₘ are the physical material variables obtained using filter, Heaviside projection, and a tailored Hypercube-to-Simplex Projection (HSP) mapping on ξ^{(k)}. The filter and Heaviside projection on both design variables facilitate regularized, mesh-independent, and discrete optimized designs. The tailored HSP mapping for material variables enforces the condition

$${\sum }_{1}^{{N}_{m}} ( {\overline{m}}_{e}^{( i )} ) = 1$$

to represent a physical structure, where candidate material i occupies the

$${\overline{m}}_{e}^{( i )}$$

portion in element e.

Here, the Heaviside projection is a numerical technique used in topology optimization to create clear, discrete boundaries between material and void regions in a design domain. It modifies a design variable, typically ranging continuously between 0 and 1, to force it toward binary values (0 or 1) based on the Heaviside step function. This is done to overcome intermediate material densities that are permitted in optimization algorithms like SIMP (Solid Isotropic Material with Penalization). The Heaviside projection improves the manufacturability and physical realism of the structure by providing sharply defined material distributions.

While

$${\overline{ρ}}_{e} and {\overline{m}}_{e}^{( i )}$$

take on binary values of 0 and 1 for an optimized design, they may take intermediate values between 0 and 1 during the optimization steps for an intermediate design. Such intermediate values necessitate the interpolation of dissimilar material properties, i.e., stiffness and strength, to characterize the mechanical behavior of intermediate designs during optimization.

For stiffness interpolation, a SIMP-based multimaterial stiffness interpolation scheme is adopted. The interpolated stiffness tensor is expressed as:

$${C}_{e}^{( ξ )} ( {\overline{ρ}}_{e} , {\overline{m}}_{e}^{( 1 )} , ... , {\overline{m}}_{e}^{( {N}_{m} )} ) = [ ε + ( 1 - ε ) {{\overline{ρ}}_{e}}^{{p}_{ρ}} ] {\sum }_{1}^{{N}_{m}} {( {\overline{m}}_{e}^{( i )} )}^{{p}_{ξ}} {C}^{( i )} \qquad ( 1 )$$

Where [symbol] ⁽ⁱ⁾ is the stiffness tensor of material phase i, p_{ρ} and p_{ξ}, are the density and material variable penalization parameters, respectively, and ε is a sufficiently small number to prevent numerical singularity. For an anisotropic (i.e., transversely isotropic) material phase, the matrix form of the stiffness tensor [symbol] ⁽ⁱ⁾ or a 2D plane stress problem is obtained from

$${C}^{( i )} {\vert}_{i = aniso} = {T}^{- 1} ( {θ}^{( i )} ) [ \begin{matrix}\frac{{E}_{11}}{1 - {v}_{12} {v}_{21}} & \frac{{v}_{12} {E}_{22}}{1 - {v}_{12} {v}_{21}} & 0 \\ \frac{{v}_{12} {E}_{22}}{1 - {v}_{12} {v}_{21}} & \frac{{E}_{22}}{1 - {v}_{12} {v}_{21}} & 0 \\ 0 & 0 & {G}_{12}\end{matrix} ] {T}^{- T} ( {θ}^{( i )} ) \qquad ( 2 )$$

Where i=1, . . . , N_{θ}, and where E₁₁ and E₂₂ are the elastic moduli along the longitudinal and transverse directions, respectively, v₁₂ is the Poisson's ratio with respect to the longitudinal direction, and G₁₂ is the shear modulus. The 2D plane stress transformation matrix T(θ⁽ⁱ⁾) corresponding to longitudinal direction θ⁽ⁱ⁾ of candidate anisotropic material phase i is given by

$$T ( θ ) = [ \begin{matrix}{cos}^{2} ( θ ) & {sin}^{2} ( θ ) & 2 sin ( θ ) cos ( θ ) \\ {sin}^{2} ( θ ) & {cos}^{2} ( θ ) & - 2 sin ( θ ) cos ( θ ) \\ - sin ( θ ) cos ( θ ) & sin ( θ ) cos ( θ ) & {cos}^{2} ( θ ) - {sin}^{2} ( θ )\end{matrix} ] \qquad ( 3 )$$

For an isotropic material phase, the matrix form of the stiffness tensor [symbol] ⁽ⁱ⁾ for a 2D plane stress problem is obtained as

$${C}^{( i )} {\vert}_{i = iso} = \frac{{E}_{iso}}{1 - {v}_{iso}^{2}} [ \begin{matrix}1 & {v}_{iso} & 0 \\ {v}_{iso} & 1 & 0 \\ 0 & 0 & \frac{1 - {v}_{iso}}{2}\end{matrix} ] \qquad ( 4 )$$

Where Eᵢₛₒ and vᵢₛₒ are the elastic modulus and Poisson's ratio, respectively.

For dissimilar strength interpolation, this work adopts an anisotropic yield function interpolation scheme that simultaneously considers anisotropic (i.e., transversely isotropic) Tsai-Wu and isotropic von Mises yield criteria. The SIMP-like interpolation for multimaterial yield function

$${f}_{e}^{( ξ )}$$

is obtained as

$${f}_{e}^{( ξ )} ( {\overline{m}}_{e}^{( 1 )} , ... , {\overline{m}}_{e}^{( {N}_{m} )} , {σ}_{e}^{( 1 )} , ... , {σ}_{e}^{( {N}_{m} )} ) = {\sum }_{1}^{{N}_{m}} {( {\overline{m}}_{e}^{( i )} )}^{{p}_{{f}_{ξ}}} {f}^{( i )} ( {σ}_{e}^{( i )} ) \qquad ( 5 )$$

$$Where {σ}_{e}^{( i )} := {C}^{( i )} {ϵ}_{e} and {f}^{( i )} ( σ )$$

are the stress state and yield function respectively corresponding to ith candidate material phase for element e, ϵₑ is the strain field for element e, and p_{ƒ}_{_{ξ}} is penalization parameter. For an anisotropic material phase, the yield function ƒ⁽ⁱ⁾(σ⁽ⁱ⁾) is obtained from the load factor-based Tsai-Wu yield criterion as

$${f}^{( i )} ( {σ}^{( i )} ) {\vert}_{i = aniso} = {η}^{( tw )} ( {σ}^{( i )} , {θ}^{( i )} ) = \frac{2 A ( {σ}^{( i )} , {θ}^{( i )} )}{\sqrt{{B}^{2} ( {σ}^{( i )} , {θ}^{( i )} ) + 4 A ( {σ}^{( i )} , {θ}^{( i )} )} - B ( {σ}^{( i )} , {θ}^{( i )} )} \leq 1 \qquad ( 6 )$$

Where η^{(tw)}(σ, θ) is the load factor. Also,

$$A ( σ , θ ) = max ( {F}_{11} {σ}_{11}^{2} + {F}_{22} {σ}_{22}^{2} + {F}_{66} {σ}_{12}^{2} + {F}_{12} {σ}_{11} {σ}_{22} , {10}^{- 12} ) and B ( σ , θ ) = {F}_{1} {σ}_{11} + {F}_{2} {σ}_{22}$$

are the quadratic and linear parts of the actual Tsai-Wu yield criterion, which is expressed for a 2D plane stress problem as

$${f}^{( tw )} ( σ , θ ) = {F}_{11} {σ}_{11}^{2} + {F}_{22} {σ}_{22}^{2} + {F}_{66} {σ}_{12}^{2} + {F}_{12} {σ}_{11} {σ}_{22} + {F}_{1} {σ}_{11} + {F}_{2} {σ}_{22} \leq 1 \qquad ( 7 )$$

Where σ₁₁, σ₂₂, and σ₁₂ are the in-plane stress components with respect to the longitudinal direction. The coefficients in Equation 7 are given by

$$\begin{matrix}{F}_{1} = \frac{1}{{X}_{t}} - \frac{1}{{X}_{c}} & {F}_{2} = \frac{1}{{Y}_{t}} - \frac{1}{{Y}_{c}}\end{matrix} \qquad ( 8 )$$

$${F}_{11} = \frac{1}{{X}_{t} \cdot {X}_{c}} \qquad {F}_{22} = \frac{1}{{Y}_{t} \cdot {Y}_{c}}$$

$${F}_{66} = \frac{1}{S \cdot S} \qquad {F}_{12} = - 0.5 \sqrt{{F}_{11} {F}_{22}}$$

Where Xₜ and X_{c} denote the tension and compression strengths along the longitudinal direction, respectively, Yₜ and Y_{c} denote the tension and compression strengths along the transverse direction, respectively, and S denotes the shear strength. For an isotropic material phase, the yield function ƒ⁽ⁱ⁾(σ⁽ⁱ⁾) is the von Mises yield criterion expressed as

$${f}^{( i )} ( {σ}^{( i )} ) {\vert}_{i = iso} = {f}^{( vm )} ( {σ}^{( i )} ) = \frac{{σ}_{vm} ( {σ}^{( i )} )}{( {\overline{σ}}_{iso} )} \leq 1 \qquad ( 9 )$$

Where σᵥₘ(σ) is the von Mises stress, and σ̅ᵢₛₒ is the von Mises stress limit for the isotropic material phase.

The load factor-based Tsai-Wu criterion reduces to von Mises criterion when Xₜ=X_{c}=Yₜ=Y_{c}=\sqrt{3}S=σ̅ᵢₛₒ. Hence, this load factor-based Tsai-Wu criterion is used in the yield function interpolation scheme instead of the actual Tsai-Wu criterion for a consistent and uniform interpolation with the von Mises criterion.

### B. Optimization Formulation

Based on the multimaterial design parameterization and material interpolation schemes, an optimized formulation is presented to minimize the weighted sum of compliance and mass of the structure. This objective function aims to obtain a lightweight design with sufficient stiffness. Polynomial vanishing stress constraints with accelerated convergence properties are used to satisfy individual yield criteria of anisotropic and isotropic material phases in the optimized design. Minimizing compliance and mass together results in a lightweight and stiff structure, whereas the stress constraints enhance the overall structural strength by preventing premature material failure. The topology optimization problem is formulated as

$${min}_{ρ , {ξ}^{( 1 )} , ... , {ξ}^{( {N}_{ξ} )}} J ( ρ , {ξ}^{( 1 )} , ... , {ξ}^{( {N}_{ξ} )} ) = wC + ( 1 - w ) {\sum }_{i = 1}^{{N}_{m}} {\hat{γ}}_{i} {V}_{i} \qquad ( 10 )$$

$$Such that$$

$${g}_{e} ( ρ , {ξ}^{( 1 )} , ... , {ξ}^{( {N}_{ξ} )} , U ) = [ ε + ( 1 - ε ) {{\overline{ρ}}_{e} ( ρ )}^{{p}_{ρ}} ] ( {f}_{e}^{( ξ )} ( {ξ}^{( 1 )} , ... , {ξ}^{( {N}_{ξ} )} , U ) - 1 ) ( {( {f}_{e}^{( ξ )} ( {ξ}^{( 1 )} , ... , {ξ}^{( {N}_{ξ} )} , U ) - 1 )}^{2} + 1 ) \leq 0$$

$$With$$

$$K ( ρ , {ξ}^{( 1 )} , ... , {ξ}^{( {N}_{ξ} )} ) U = {F}^{ext}$$

$$Where e = 1 , ... , {N}_{e} , {ρ}_{e} ∈ [ 0 , 1 ] , {ξ}_{e}^{( k )} ∈ [ 0 , 1 ] , and k = 1 , ... , {N}_{ξ} . Also$$

$$C = \frac{{( {F}^{ext} )}^{T} U ( ρ , {ξ}^{( 1 )} , ... , {ξ}^{( {N}_{ξ} )} )}{{C}^{*}}$$

Where C is the normalized end-compliance with C* being the end-compliance of uniform initial guess. Also the structural volume fraction occupied by material phase i is given by

$${V}_{i} = \frac{{\sum }_{e = 1}^{{N}_{e}} ( {\overline{ρ}}_{e} ( ρ ) {\overline{m}}_{e}^{( i )} ( {ξ}^{( 1 )} , ... , {ξ}^{( {N}_{ξ} )} ) {v}_{e} )}{{\sum }_{e = 1}^{{N}_{e}} {v}_{e}}$$

Where vₑ is the volume of element e. Also, \hat{γ}ᵢ=γᵢ/maxγᵢ where γᵢ ∈[0,1] is the infill density for the material phase i, w∈[0,1] is a weight factor for the compliance term in the objective function of Equation 10,

$${f}_{e}^{( ξ )} ( {ξ}^{( 1 )} , … , {ξ}^{( {N}_{ξ} )} , U ( ρ , {ξ}^{( 1 )} , … , {ξ}^{( {N}_{ξ} )} ) )$$

is the interpolated yield function value associated with element e, K(ρ, ξ⁽¹⁾, . . . , ξ^{(N}^{_{ξ}}⁾) the global stiffness matrix obtained from the stiffness interpolation of Equation 10, U is the global displacement vector, F^{ext} is the global external force vector, and Nₑ is the total number of elements in the discretized finite element mesh.

Note that simultaneous inclusion of Nₑ nonlinear stress constraints evaluated at the center of the Nₑ elements increases the complexity of the optimization problem set forth in Equation 10. To efficiently handle many local constraints, this study adopts an Augmented Lagrangian (AL) based formulation with appropriate scaling. The AL method preserves the local nature of stress and avoids the risk of stress constraints not being satisfied everywhere. Note that, because voxel-based mesh is used in the optimization process, jagged boundary representation in the mesh would cause stress estimation error. To address this issue, a finite element check can be performed for the final optimized design with body-fitted mesh before fabrication.

Put another way, Equation 10 can be considered to have three parts. This first is the objective function, which involves design density variable ρ that characterizes the geometry of the structure to be manufactured, and the series of ξ variables characterize the anisotropic and isotropic material phases in the design (e.g., the orientations of infills within the structure). The values of ρ and ξ can be optimized so that a design goal involving stiffness and volume is achieved. Here, C represents the inverse of stiffness, so it can be minimized to maximize stiffness. Also, \hat{γ}ᵢ represents the respective mass (infill) density and Vᵢ represents the respective volume fraction of different material phases in the structure. The term w is a weight factor. Put together, the goal of the objective function is to find values of ρ and ξ that maximize stiffness and minimize volume.

The second part involves the function gₑ, which provides a series of stress constraints that characterize maximal levels of stress at various points and orientations with respect to the structure such that the structure can tolerate a prescribed load without failing. The strength anisotropy and/or isotropy of each type of printing path is also considered through these constraints, notably in Equation 5. Combined with the objective function, this results in the structure being able to withstand the prescribed loads while maximizing its stiffness and minimizing its volume.

The third part is the mechanics problem being solved, namely K(ρ, ξ⁽¹⁾, . . . , ξ^{(N}^{_{ξ}}⁾)U=F^{ext}. Here, K is the global stiffness matrix, U is a global displacement vector, and F^{ext} represents externally-applied forces. The global stiffness matrix K incorporates the stiffness anisotropy and/or isotropy of each type of printing paths in the mechanics problem. Additionally, N_{ξ} denotes the number of design variables required to characterize the different types of print paths, and Nₑ represents the number of elements in a discretized finite element mesh representing the characteristics of the structure.

With these properties populated, optimization solver software can be used to find values for ρ and ξ. For instance, the Method of Moving Asymptotes (MMA) could be used, but other techniques may be employed instead. In some cases, the finite element mesh may be reconstructed, at least in part, between iterations of the optimization, and the parameters of subsequent iterations of the optimization may be selected in part based on a gradient determined between the current iteration and one or more previous iterations. In experiments, the optimization formulation was implemented in Matlab and required about 14 hours with 1350 optimization iterations (each with 5 inner iterations for the AL unconstrained sub-problem) in a 64 GB RAM Intel(R) Xeon(R) Silver 4116 CPU @ 2.10 GHz processor.

Once solved and the values for ρ and ξ are determined, these values and other underlying characteristics of the material that is to be used to manufacture the structure can be provided as a digital model of the structure to an additive manufacturing system. Such a system may employ 3D printing to create three-dimensional objects by sequentially adding material, layer by layer. In the embodiments herein, the additive manufacturing system may support process-induced anisotropy so that anisotropic parts of the structure can be printed.

The core components of an additive manufacturing system may include a digital model, a material deposition mechanism, a build platform, and a control system. The process begins with the creation or loading of the digital model. This digital model is then sliced into thin horizontal layers, which serve as the blueprint for the printing process.

The material deposition mechanism, which can vary depending on the specific type of additive manufacturing technology, is responsible for laying down the material. Common methods include fused deposition modeling (FDM), where thermoplastic filaments are melted and extruded through a nozzle; selective laser sintering (SLS), where a laser fuses powdered material; and stereolithography (SLA), where a laser cures photopolymer resin. The build platform provides a stable base upon which each successive layer of material is deposited. The control system, governed by software, orchestrates the precise movement of the deposition mechanism and the build platform, ensuring that each layer is accurately placed according to the digital model.

The additive manufacturing process proceeds layer by layer, with the material being selectively added to form the desired shape. As each layer is completed, the build platform may lower (or the deposition mechanism may raise) to allow the addition of the next layer. This additive approach allows for the creation of complex geometries and internal structures that would be difficult or impossible to achieve with traditional subtractive manufacturing methods. The final product is a physical realization of the structure represented by the digital model.

### C. Fabrication

The optimization formulation of Equation 10 is combined with process-induced anisotropy from material extrusion 3D printing to fabricate stiff, strong, and lightweight structures with anisotropic and isotropic material phases. This section presents a possible fabrication strategy for anisotropic and isotropic parts together with their interfaces in the optimized designs.

Material extrusion 3D printing is used to generate both anisotropic and isotropic material phases by controlling the direction of the line type infill, i.e., print path inside the parts. For an anisotropic material phase, a single infill direction is assigned for all layers to realize the longitudinal direction, i.e., the direction with high stiffness and strength. For isotropic material phase, direction-independent stiffness and strength are approximately realized by using the line type infill orientated in the same direction for a single layer, but gradually changing from −90° to 90° in 30° increments at consecutive infill layers as the layer height increases.

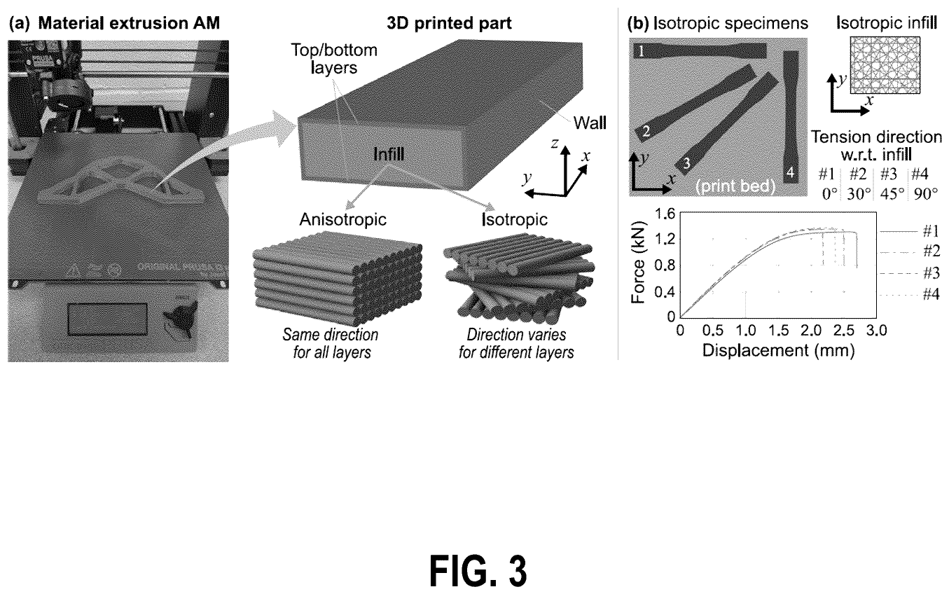

FIG. 3 part a shows the fabrication setup for anisotropic and isotropic infill patterns, and FIG. 3 part b shows the force-displacement responses of four uniaxial tension specimens printed in different orientations with same isotropic infill. The force-displacement curves indicate that the stiffness (represented by the slopes) and the strength (represented by the peak forces) remain almost the same for different orientations of adopted isotropic infill with respect to applied stress direction. The 30° increment works sufficiently well for this study with 1.2% and 3.2% deviations from mean values in Eᵢₛₒ and σᵢₛₒ, respectively. A larger increment, such as 45°, gives larger deviations (˜6.8% and ˜5.9% deviations from mean values in Eᵢₛₒ and σᵢₛₒ, respectively). In the case where printed material has very high anisotropy, a smaller increment may be necessary to imitate better the isotropic behavior for printed parts. A suitable increment value may be decided by ensuring that the deviations from mean values in Eᵢₛₒ and σᵢₛₒ for different loading and infill directions are within an acceptable upper bound.

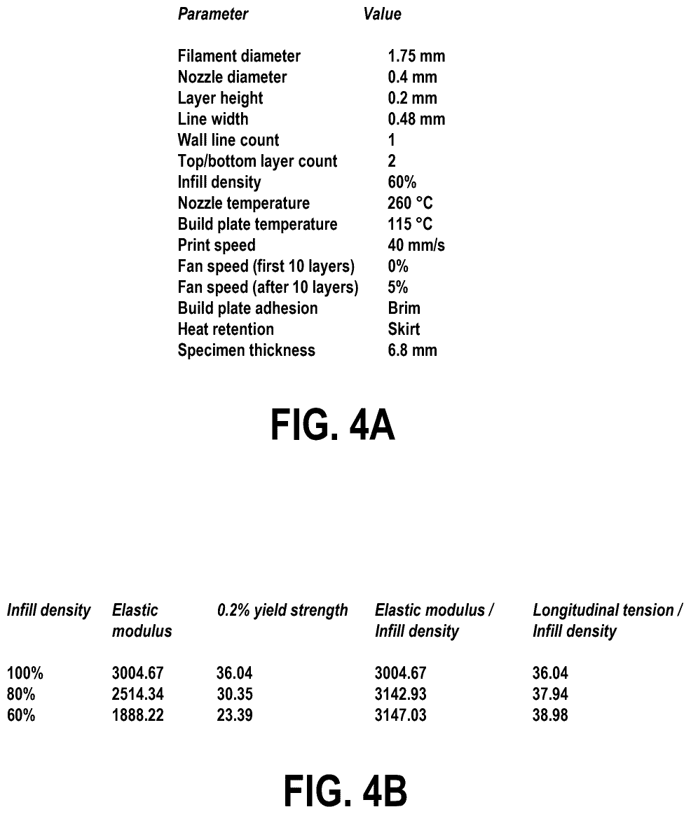

The open-source slicing software Ultimaker Cura 5.1.1 is used to assign infill directions and generate G-codes for the anisotropic and isotropic parts, which are then printed using Original Prusa i3 MK3S 3D printer and 3DxTech CarbonX ABS+CF (ABS with carbon fiber) filament. Some relevant print parameters are listed in FIG. 4A.

Note that these examples use 60% infill density for anisotropic and isotropic parts, which implies that the material amount used to print the infill is ˜60% of the total available infill space. The adopted infill density allows relatively stronger interface fabrication for the optimized structures without compromising the stiffness- and strength-to-mass ratios of the printed parts. The uniaxial test results in FIG. 4B indicate that the adopted 60% infill density has slightly better stiffness and strength per unit infill density compared to 80% and 100% infill densities (along longitudinal direction for the anisotropic material phase) for the used ABS+CF material.

However, infill densities lower than 60% are avoided as they risk unwanted premature failures due to large infill gaps and delamination. A higher number of wall lines and top and bottom layers are avoided to occupy larger cross-section areas with infill regions. Specimen out-of-plane thickness is adjusted considering various factors. While a thicker specimen is desired to avoid out-of-plane buckling and to increase the effective infill area in cross-section, an overly thick specimen may severely violate the plane stress assumption. In this work, specimen thickness is also restricted by the allowable gripping space between the test fixtures. Other listed print parameters in FIG. 4A are primarily related to ensuring acceptable print quality, and may need calibration for different print materials and 3D printers. Changing the print parameters can affect the relevant material properties (i.e., stiffness and strength parameters) as well as the anisotropy of the printed parts. In such cases, the optimized designs and force-displacement responses of the fabricated specimens are expected to vary from the results presented herein.

An aspect of optimized structure fabrication is the realization of simulated interface behavior between different material phases. As the adopted numerical formulation does not specifically account for interface strength and stiffness, it inherently assumes that any interface line is at least stronger than the weakest material phase connected to the interface. The numerical modeling is based on the assumption that the interface lines between two material phases are sufficient (i.e., stronger than at least the weakest neighboring material phase); thus, failure will occur in one of the neighboring material phases (instead of exactly at the interface line). Preliminary experimental investigations using a vertical interface (i.e., not s-shaped) showed that such an interface might fail before the neighboring material phases.

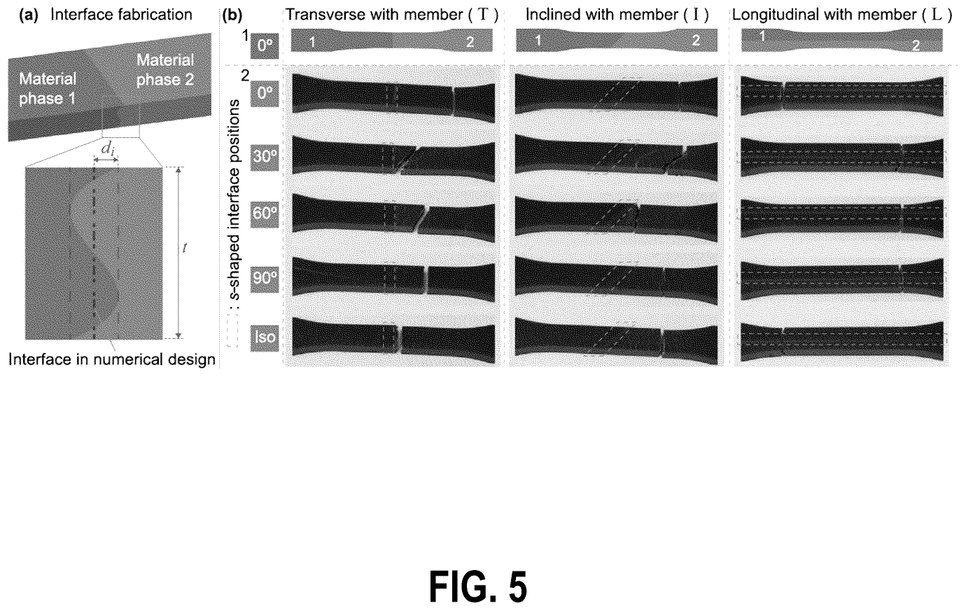

Since this observation violates the assumption in the numerical framework, an s-shaped interface geometry (see FIG. 5 part a) can be used for the material interfaces in the optimized designs to increase adhesion between the neighboring material phases and make the interface stronger than the connected material phases. The multiple joining material phases are 3D printed as a group (i.e., simultaneously) in a single attempt, without using any adhesive. This s-shaped interface fabrication not only makes the interface stronger, but also makes the interface region suitable for multi-axial load paths by enabling multiple infill orientations throughout the cross-section. The interface strength behavior is verified by uniaxial tension tests performed on specimens having different material phases.

FIG. 5 part b presents 5 cases of interface tests, where material phase 1 is always fabricated with 0° infill direction, and material phase 2 is varied with different anisotropic (0°, 30°, 60°, 90°) and isotropic infills. For each case, three interface orientations are considered that are transverse, inclined, and longitudinal with the tension specimen. These three variations in interface orientations approximately represent the various possible interface orientations with respect to the load paths in the optimized designs.

FIG. 5 part b indicates that this s-shaped interface has higher strength compared to all material phases for all three types of interface orientations, as the failure locations are observed outside interfaces for all test cases. The higher interface strength can be attributed to the horizontal adhesion of printed layers and high local infill density at the interface region compared to the adjacent members. The high local infill density also increases the stiffness of the interfaces.

Mechanical tests were performed for different anisotropic and isotropic phases to characterize their elasticity and strength parameters. As the topology optimization formulation uses linear elastic assumption, elasticity parameters were estimated from the initial, approximately linear part (within ˜1% strain) of the test responses. Strength parameters were obtained from the 0.2% offset yield strength estimates. Material properties in tension and compression are obtained by following the methodologies in ASTM D635 and ASTM D695 standards, respectively. Shear properties are estimated using the same specimen geometry of the tension tests and following ASTM D3518 method, which recommends approximate shear response estimation from uniaxial tests of ±45° laminates.

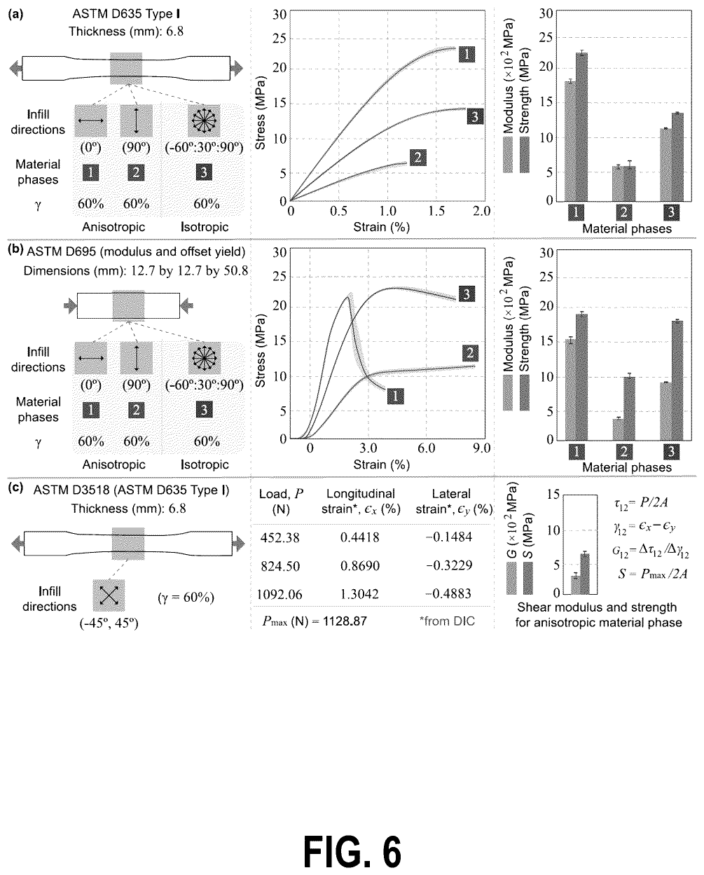

FIG. 6 summarizes the material characterization tests, including the specimen specifications, representative experimental data, and estimated average elasticity and strength parameters. The first two rows show the tension and compression test results for the anisotropic and isotropic phases, and the third row illustrates the adopted approach to estimate approximate shear parameters for the anisotropic phase. For each test case, 5 tests are performed using an INSTRON 68TM-30 universal loading machine to estimate average material parameters. The Poisson's ratios of anisotropic and isotropic material phases and the shear modulus of the anisotropic material phase are estimated by performing Digital image correlation (DIC) with the Ncorr (Matlab) software and a SONY FE 2.8/24-70 GM II camera.

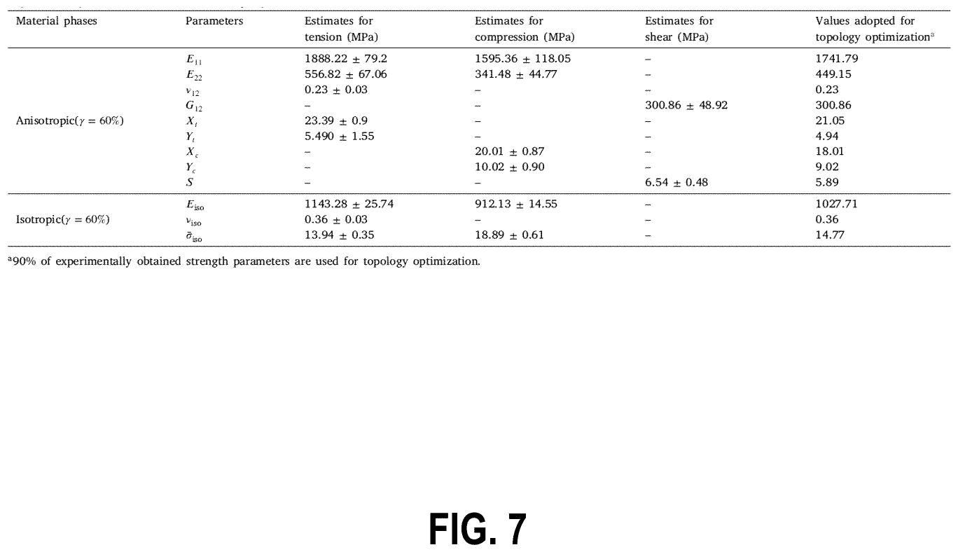

FIG. 7 lists the final elasticity and strength parameter values adopted for topology optimization examples discussed in the experimental results below. The adopted elastic moduli for both anisotropic and isotropic material phases and von Mises strength for isotropic material phases are taken as average values from tension and compression to adapt to the topology optimization framework presented in II.B. Furthermore, 90% of the experimentally obtained strength parameters are adopted for optimization to compensate approximate stress estimation error from FEA discretization, design post-processing from jagged to smooth boundaries, and various fabrication uncertainties.

### D. Experimental Results

This section presents the advantages of the proposed methodology in additive manufacturing of lightweight, stiff, and strong structures with design optimization, fabrication, and experimental investigations. The first example shows structural strength enhancement with anisotropic stress constraints; the second example illustrates the advantages of using optimized infill orientations and s-shaped interfaces in optimized design fabrication; and the third example demonstrates the effect of considering tension-compression strength asymmetry on design optimization and failure behavior. The examples with design optimizations predict satisfaction or violation for Tsai-Wu and von Mises yield criteria corresponding to candidate anisotropic and isotropic material phases, respectively, with the yield function measure (YFM) fringe plots. This yield function measure is calculated as

$$YFM = [ ε + ( 1 - ε ) {{\overline{ρ}}_{e} ( ρ )}^{{p}_{ρ}} ] {f}_{e}^{( ξ )} ( {ξ}^{( 1 )} , ... , {ξ}^{( {N}_{ξ} )} , U )$$

The yield function and performs similarly as a normalized stress measure with YFM>1 indicating yield criterion violation. While this study considers six or eight candidate anisotropic orientations for the demonstrated examples, a different number of candidate orientations may be considered for design problems with different dimensions, material properties, and fabrication methodologies. In general, very few candidate orientations may reduce the performance improvement, whereas too many candidate orientations may lead to increased computational cost and many closely-spaced interface regions.

### 1. Example of Structural Strength Enhancement

A first example compares two design cases to demonstrate the increase in structural strength with anisotropic stress-constrained topology optimization. The first case minimizes the objective function in Equation 10 (i.e., the weighted sum of normalized mass and compliance) without considering the stress constraints, while the second case minimizes the same objective with stress constraints. Both cases include anisotropic and isotropic material phases with infill density γ=60%, and a compliance weight factor w=0.35.

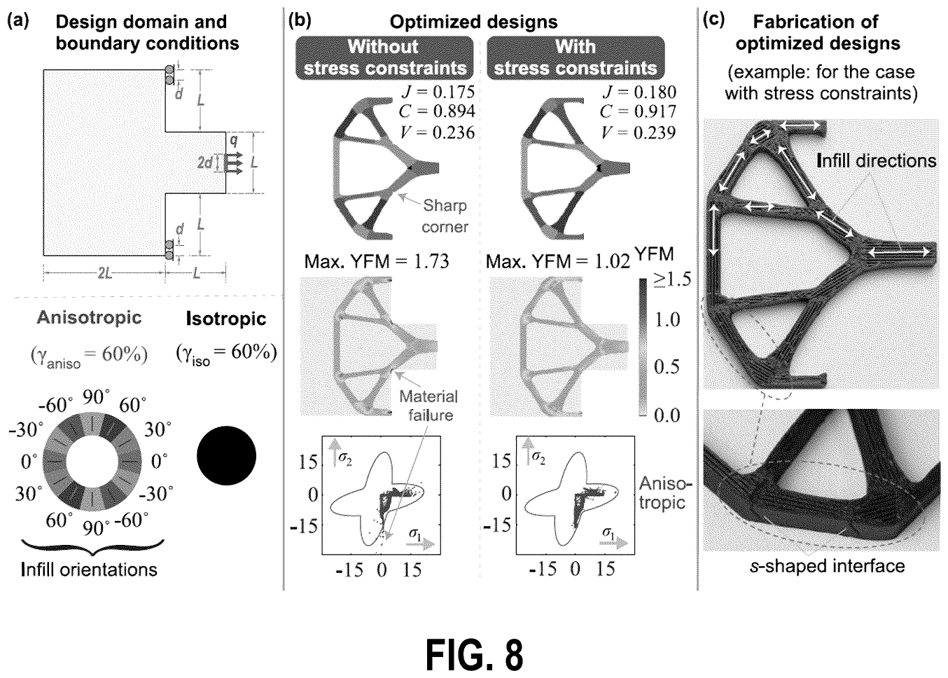

FIG. 8 part a shows the design domain and candidate material phases, with six pre-selected infill orientations for the anisotropic material phase. FIG. 8 part b discusses the optimized designs along with their YFM fringe plots and principal stress states with yield surface contours. FIG. 8 part c presents an example of a partially complete fabricated design to illustrate printed infill directions inside the specimen and s-shaped interfaces.

For the design optimized without stress constraints, several locations (especially two sharp corners) in the design have YFM values exceeding 1 and principal stress states outside the yield surface contours, both indicating premature failure of the structure by local stress state exceeding material strength. In contrast, the design optimized with stress constraints restricts the maximum YFM value to 1, i.e., restricts the principal stresses to be inside the yield surface contour throughout the design. In presence of stress constraints, the optimizer marginally increases the compliance and material usage to partially remove the sharp corners and avoids stress concentration beyond material strength. Notice that, for both design cases, the optimizer chooses the infill orientations closest to the directions of principal stress paths at any location to increase structural stiffness while minimizing volume. This process implicitly also increases the structural strength, i.e., load carrying capacity, as infills oriented along stress paths usually provide most strength. However, the second design case with stress constraints increases the structural strength both implicitly by aligning infills along stress paths, and also explicitly by suitable changes in structural geometry.

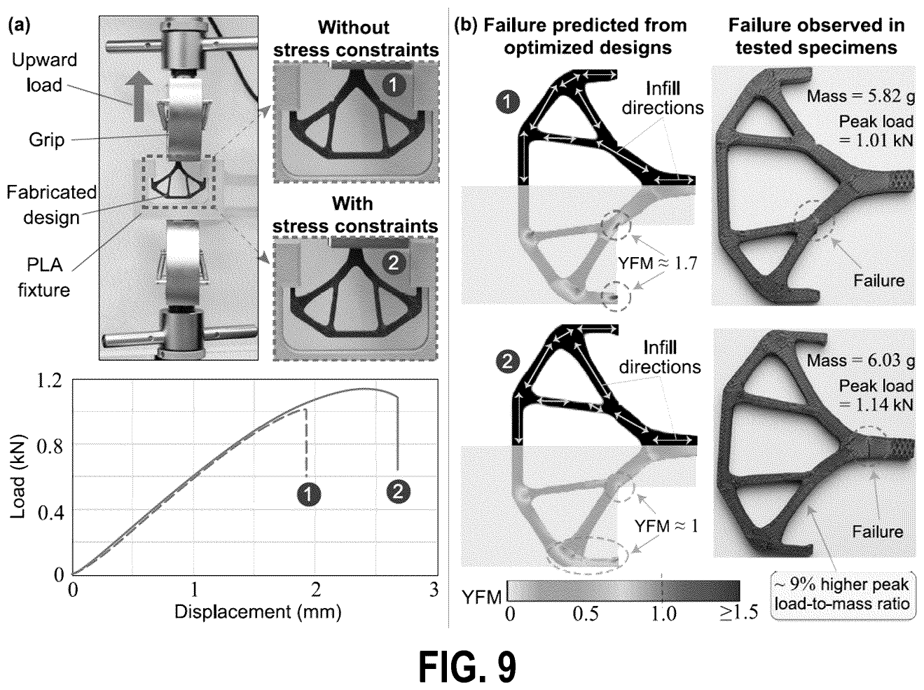

The optimized designs obtained from the two design cases are fabricated and tested to validate the predicted enhanced structural strength with anisotropic stress-constrained topology optimization. FIG. 9 part a shows the test setup, tested specimens corresponding to the two design cases, and their load-displacement histories. The roller boundary condition in design domain (see FIG. 8 part a) is realized using a 20 mm thick PLA-printed fixture having 100% infill density. The fabricated specimens are loaded until failure with a 1.5 mm/min displacement rate. The experimentally observed trend in stiffness and strength performances of the two structures are consistent with the predicted numerical results from FIG. 8 part a. The load-displacement plot shows that the specimen optimized with stress constraints attains a higher peak load before failure and similar structural stiffness (i.e., slope of the load-displacement curve) compared to the specimen optimized without stress constraints.

FIG. 9 part a compares the predicted failure locations (with YFM fringe plots) for the optimized designs from FIG. 8 part b and the observed failure locations in the tested specimens. For the design case without stress constraints, stress concentration with YFM exceeding 1 is observed near the sharp corners, the supports, and at some member interfaces. The corresponding fabricated specimen fails from one of the sharp corners, which indicates a close match with predicted failure. For the design case with stress constraints, some stress concentration is predicted near the partially removed sharp corners, supports, and some member interfaces. However, comparatively lower YFM values (≈1) at those stress concentration regions results in a higher failure load for the corresponding fabricated specimen. In this case, the fabricated design uses a slightly more material amount and different topology to enhance the peak load-to-mass ratio by 9%.

Note that, the fabricated s-shaped interfaces have multi-axial infills and higher infill densities than the interfaces in the numerical model. As a result, the tested specimen for the stress-constrained case does not fail at the interface as predicted. The prediction can be more accurate by exclusively modeling accurate stiffness and strength properties for the interface regions. However, exclusive modeling of s-shaped interfaces may increase the complexity of the optimization framework. Here, the adopted fabrication approach further enhances the strength of printed structures by strengthening the joints, which are often the weakest parts in structures optimized for high stiffness using unidirectionally stiff and strong anisotropic material phases.

### 2. Example of Stiff, Strong, and Lightweight Fabrication

A second example illustrates the advantages of optimized infill and s-shaped interface fabrication in material extrusion-based additive manufacturing of stiff, strong, and lightweight structures. The topology (i.e., structural geometry) of the design optimized with stress constraints from previous example is used with different infill generation methods commonly used in material extrusion 3D printing to fabricate different test structures. These test structures do not involve any infill optimization and s-shaped interfaces.

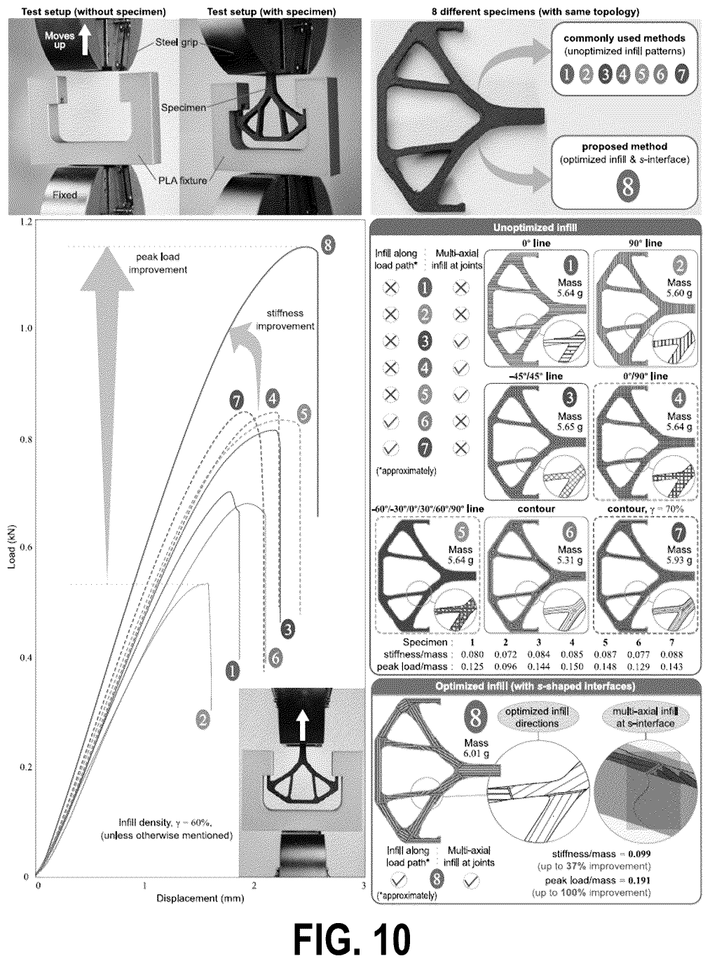

FIG. 10 compares the structural stiffness (i.e., slope of load-displacement curve), strength (i.e., peak load), and material used (i.e., mass) of the fabricated test structures with the design having optimized infill and s-shaped interfaces. The load-displacement plot shows the superior overall structural stiffness and strength resulting from the proposed optimization and fabrication method. Note that, the optimized-infill structure uses more amount of material because of the adopted s-shaped interface fabrication, as the infill densities (γ) near such interfaces becomes higher than 60%. Despite using more material, the optimized-infill structure obtains higher stiffness- and peak load-to-mass ratios, indicating efficient material usage.

The high stiffness and strength performance per unit mass is mostly attributed to infill orientations aligned with load paths in the structure. In this example, the load paths are mostly uniaxial in slender members and multi-axial in joints, i.e., at the intersection of multiple members, and they are oriented approximately along the member lengths. Among test cases 1 and 2, the former has more members with infill oriented along load paths and therefore achieves a higher stiffness- and peak load-to-mass ratio. Test cases 3, 4, and 5 have higher stiffness- and peak load-to-mass ratio compared to test cases 1 and 2, as the latter ones have uniaxial infill in the joints with multi-axial load paths. Test cases 3, 4, and 5 show similar stiffness- and load-to-mass ratio as each of these structures has some part of their multi-axial infill orientated along the load paths in all members. Test case 6 with contour infill has lower stiffness- and peak load-to-mass ratio despite having infills aligned with load paths in the members. The probable reason is the voids at the joints, which significantly decrease the overall stiffness and strength of the structure. Test case 7 with the same contour infill and a higher infill density (γ=70%) fills most of the voids at the joints and therefore shows stiffness- and peak load-to-mass ratios comparable to test cases 3, 4, and 5. Test case 8 with optimized infill has infill directions in slender members mostly along load paths similar to test case 7, and therefore a similar stiffness and strength performance is expected. However, the s shape of the interfaces in test case 8 allows infills of both intersecting members to be present at the interface regions that result in multi-axial infill patterns at the joints. Moreover, the local increase in infill density near interfaces also increases the stiffness and strength of the joints. Therefore, test case 8 with optimized infill and s-shaped interface with the proposed methodology achieves a higher stiffness- and strength-to-mass ratio compared to other common infill generation methods for a topology optimized structure. Note that the proposed methodology does not require extensive load path calculation and infill programming at each location according to the stress magnitude. Instead, it bypasses the infill overlapping problem by suitable topology changes near stress concentrations and reduces the post-processing complexity for fabrication after design optimization.

### 3. Example of Tension-Compression Strength Asymmetry

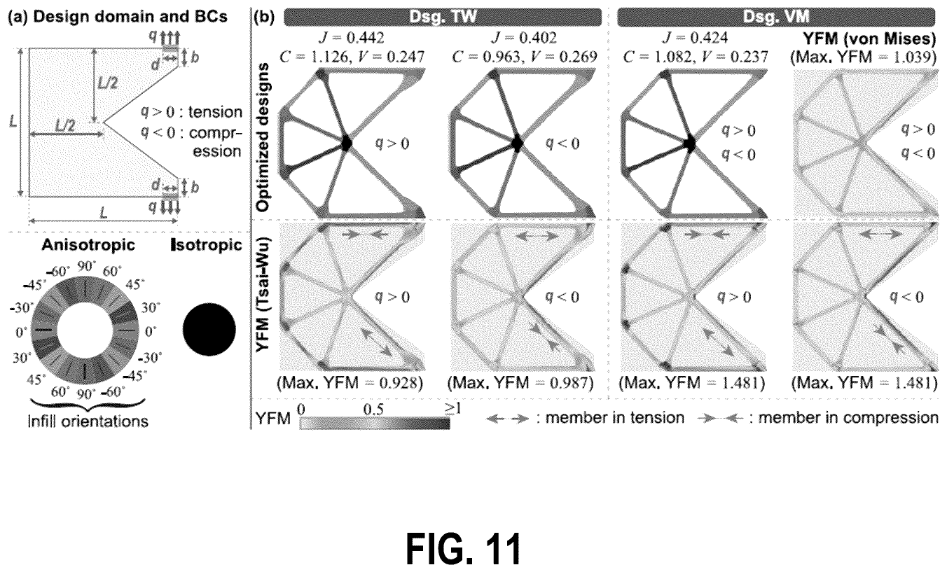

A third example demonstrates that the proposed methodology considers the tension-compression strength asymmetry of anisotropic printed parts, particularly in regions with multi-axial load paths. Two design cases are considered for comparison. The first design case, Dsg. TW, uses appropriate Tsai-Wu and von Mises criteria for anisotropic and isotropic material phases from FIG. 7, whereas the second design case Dsg. VM assumes the uniaxial longitudinal tensile strength of the anisotropic infill as a von Mises stress limit for all candidate material phases (i.e., σₗᵢₘ=Xₜ). Both design cases are optimized separately for two loading scenarios in tension and compression with the same design domain, boundary conditions, and candidate anisotropic and isotropic material phases as shown in FIG. 11 part a. FIG. 11 part b presents the optimized designs for Dsg. TW and Dsg. VM for tension and compression loading, along with their yield function measure (YFM) fringe plots. For the case Dsg. VM, the YFM plots evaluated with actual Tsai-Wu strength parameters are also included for comparison. A compliance weight factor of w=0.3 is used for all design cases in this example.

The design case Dsg. TW obtains two different optimized designs for tension and compression loading. For tension loading, the critical regions, i.e., regions with YFM≈1, are the boundary members in compression (i.e., boundary members which are not adjacent to the re-entrant corner in the design domain). For compression loading, the critical region shifts to the two boundary members adjacent to the re-entrant corner as they experience a compression stress state under compression loading. As the uniaxial strength (along infill or longitudinal direction) of the used anisotropic material phase is higher in tension compared to compression, the different members become critical for tension and compression loading according to their tension or compression stress states. In contrast, Dsg. VM design case results in the same optimized design and YFM plots for both tension and compression loading while using von Mises yield criterion, which considers equal strength in tension and compression. In both tension and compression loading, the re-entrant corner is identified as critical with maximum YFM≈1. However, the same design Dsg. VM evaluated with Tsai-Wu criterion shows maximum YFM≈1.5, indicating overestimation of material strength in Dsg. VM. Furthermore, the member interfaces and the boundary members adjacent to the re-entrant corner are also identified with high YFM for tension and compression loading, respectively, in addition to the re-entrant corner. All optimized designs prefer an isotropic material phase near the re-entrant corner, as this region has multiple load paths from many intersecting members. For all the slender members with mostly unidirectional stress paths, the optimizer prefers anisotropic material phases to increase the stiffness- and strength-to-mass ratios of the optimized designs.

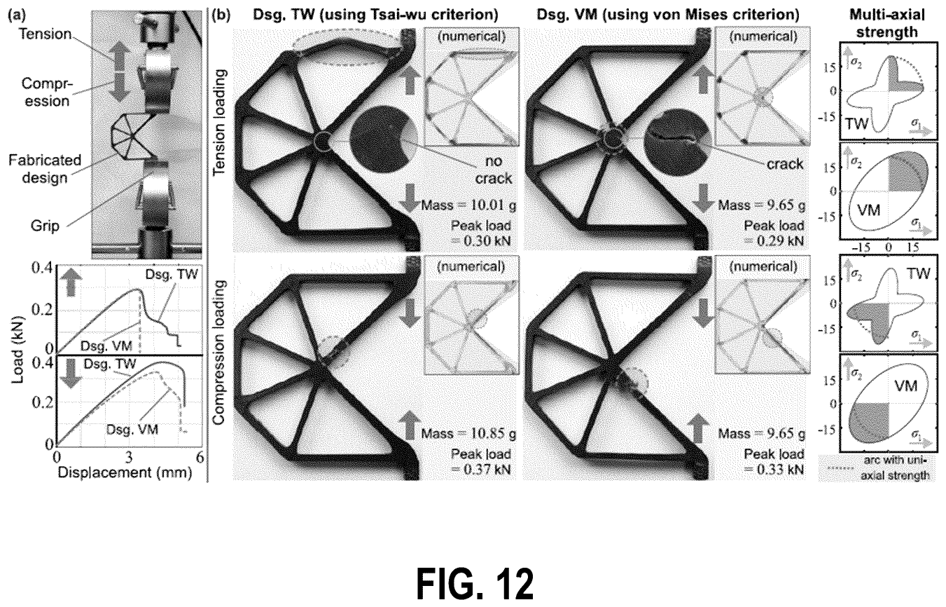

The optimized designs from Dsg. TW and Dsg. VM are fabricated and tested to compare their relative load-carrying performances and failure locations. FIG. 12 shows the test setup and load-displacement responses for tension and compression loadings on the fabricated specimens. For tension loading, both Dsg. TW and Dsg. VM specimens have near-equal structural stiffness and peak loads. However, the failure mechanisms for the two specimens are different and reflect the effect of using different strength criteria in topology optimization. The Dsg. TW specimen fails due to in-plane buckling of a member in nearly uniaxial compression, whereas the Dsg. VM specimen fails due to sharp crack propagation from a re-entrant corner which is in multi-axial tension. For compression loading, Dsg. VM and Dsg. TW have similar failure mechanisms, whereas the latter achieves a higher peak load.

For the tested specimens, the failure behaviors can be related to the adopted yield criteria for optimization and the corresponding optimized design topology. For tension loading, the re-entrant corner experiencing multi-axial tension is replaced by a smooth round-shaped geometry for Dsg. TW as the Tsai-Wu criterion assumes lesser strength in multi-axial tension compared to uniaxial tension. The Dsg. VM design retains the re-entrant corner as it overestimates the multi-axial tension strength using a von Mises criterion. As a result, the Dsg. VM fails from a sharp crack at the re-entrant corner during the experiment. While Dsg. TW fails at the same load level due to the buckling of a compression member, no crack appears at the re-entrant corner location.

For compression loading, Dsg. TW and Dsg. VM retains the re-entrant corner partially and completely, respectively, as the predicted strength in multi-axial compression can be higher than uniaxial compression for both Tsai-Wu and von Mises yield criteria. Both specimens fail at the compression member adjacent to the re-entrant corner, while Dsg. VM achieves ˜10.8% lower peak load as it overestimates the compression strength of the anisotropic material phase. Failure regions are consistently predicted with high Tsai-Wu YFM values for all design cases.

### E. Example Operations

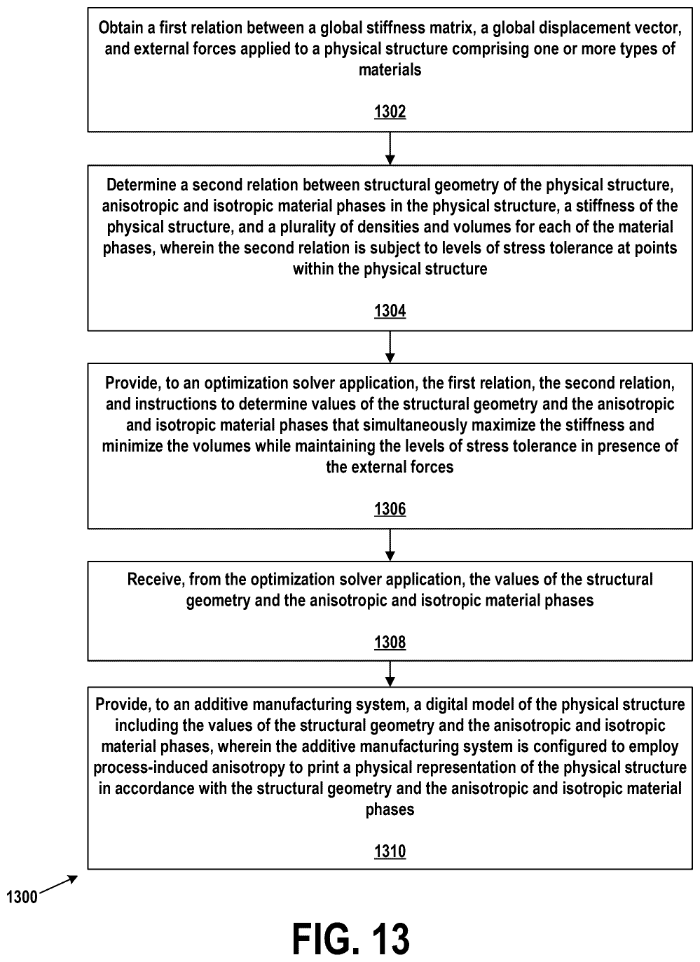

FIG. 13 is a flow chart 1300 illustrating an example embodiment. The process illustrated by FIG. 13 may be carried out by a computing device, such as computing device 100, and/or a cluster of computing devices, such as server cluster 200. However, the process can be carried out by other types of devices or device subsystems.

The embodiments of FIG. 13 may be simplified by the removal of any one or more of the features shown therein. Further, these embodiments may be combined with features, aspects, and/or implementations of any of the previous figures or otherwise described herein.

Block 1302 may involve obtaining a first relation between a global stiffness matrix, a global displacement vector, and external forces applied to a physical structure comprising one or more types of materials.

Block 1304 may involve determining a second relation between structural geometry of the physical structure, anisotropic and isotropic material phases in the physical structure, a stiffness of the physical structure, and a plurality of densities and volumes for each of the material phases, wherein the second relation is subject to levels of stress tolerance at points within the physical structure.

Block 1306 may involve providing, to an optimization solver application, the first relation, the second relation, and instructions to determine values of the structural geometry and the anisotropic and isotropic material phases that simultaneously maximize the stiffness and minimize the volumes while maintaining the levels of stress tolerance in presence of the external forces.

Block 1308 may involve receiving, from the optimization solver application, the values of the structural geometry and the anisotropic and isotropic material phases.

Block 1310 may involve providing, to an additive manufacturing system, a digital model of the physical structure including the values of the structural geometry and the anisotropic and isotropic material phases, wherein the additive manufacturing system is configured to employ process-induced anisotropy to print a physical representation of at least part of the physical structure in accordance with the structural geometry and the anisotropic and isotropic material phases.

Some embodiments may further comprise printing, by the additive manufacturing system, the physical representation of the physical structure in accordance with the structural geometry and the anisotropic and isotropic material phases while employing the process-induced anisotropy.

In some embodiments, at least one of the anisotropic material phases is printed as multiple layers of material with a fixed infill direction, and at least one of the isotropic material phases is printed by varying infill directions across successive layers.

In some embodiments, at least one of the isotropic material phases is printed by varying infill directions across successive layers by a fixed angle less than 45 degrees.

In some embodiments, the material phases are printed with infill densities from 60% to 80%.

In some embodiments, the physical structure comprises both of the anisotropic and isotropic material phases.

In some embodiments, the optimization solver application is configured to determine the values of the structural geometry and the anisotropic and isotropic material phases using an iterative process, and wherein an iteration of the iterative process comprises: decomposing the physical structure into a material phase distribution on a finite element mesh; determining, based on the finite element mesh, the values of the structural geometry and the anisotropic and isotropic material phases that simultaneously maximize the stiffness and minimize the volumes while maintaining the levels of stress tolerance in presence of the external forces; and based on a gradient between the values of the structural geometry and the anisotropic and isotropic material phases and previous values thereof from previous iterations of the iterative process, determining parameters for a new material phase distribution on the finite element mesh to be used in a subsequent iteration of the iterative process.

In some embodiments, s-shaped interface geometries are used between at least some of the material phases.

In some embodiments, the material phases with the s-shaped interface geometries are printed together.

In some embodiments, the levels of stress tolerance conform with von Mises constraints for the isotropic material phases.

In some embodiments, wherein the levels of stress tolerance conform with von Tsai-Wi constraints for the anisotropic material phases

### F. Example Technical Improvements

Additive manufacturing using material extrusion introduces process-induced anisotropy in stiffness and strength due to the directional nature of layer deposition and infill orientation. If anisotropy is not explicitly accounted for in topology optimization, fabricated structures may suffer premature failure or underperform mechanically despite appearing optimized in software. The embodiments herein address this problem by integrating anisotropic material behavior into the topology optimization formulation so that the digital design maps to manufacturable structures with superior mechanical performance.

These embodiments improve additive manufacturing machines by making them capable of outputting stronger and lighter physical components, efficiently using material (minimized volume while maximizing stiffness), and dynamically aligning material deposition paths to principal stress directions. This results in technical improvements to the operation of additive manufacturing systems themselves in the form of more reliable and structurally sound builds using less material. The use of anisotropic and isotropic phases in the same topology optimization process and s-shaped multi-material interfaces to mitigate real-world fabrication limitations combine into an unconventional, non-routine practical application to solve a physical problem.

Other technical improvements may flow from these embodiments. Therefore, this statement of technical improvement is non-limiting.

### III. Sustainability-Oriented Multimaterial Topology Optimization

The current practice of infrastructure development relies heavily on non-biodegradable mineral-based materials, such as steel, aluminum, and concrete. Various stages of their extraction, transportation, and manufacturing release a large amount of harmful substances into the environment, such as carbon and sulfur compounds, which adversely affect the biosphere on multiple fronts, including global warming, acidification of drinking water sources, and ozone layer depletion. With current infrastructure design practices, such adverse effects are likely to increase in the coming decades, at least for the construction of houses and infrastructure. To mitigate further deterioration of the environment, many governments and construction companies now encourage sustainable construction strategies. Among various innovative directions, one direction involves the gradual and partial replacement of conventional building materials with environment-friendly alternatives. Recently, bio-based materials such as laminated timber and bamboo products emerged as promising alternatives because of their superior environmental sustainability and industrial practicality in mechanical performance, fabrication, and maintenance. These bio-based materials not only release significantly less harmful substances compared to metals such as steel and aluminum, but also help the environment with carbon sequestration during their growing phase. Furthermore, bamboo and timber also show impressive stiffness and strength per unit mass due to their natural fibrous microstructure. Studies suggest that these bio-based materials can provide sufficient stiffness and strength for low- and mid-rise buildings that account for most new constructions.

Despite the above-mentioned developments, fundamental advancements are needed in several aspects to facilitate the widespread adoption of bio-based materials to enable high-performance and sustainable civil structures. Bio-based materials in structural design come with various challenges. Most bio-based materials are inherently anisotropic due to their fibrous microstructures. Inefficient utilization of these materials could lead to either early local material failure or overly conservative structural systems with redundant material usage, which may hurdle the adoption of those materials in challenging construction projects with high strength- and stiffness-to-weight requirements, such as high-rise and long-span structures. Depending on procurement and manufacturing practices, a large amount of biobased members may also incur a higher price compared to thin steel members that provide similar mechanical (stiffness and strength) performances. Hence, optimized multimaterial structures that harness the stiffness and strength advantages of conventional material (e.g., steel) and the environmental benefits of bio-based materials (e.g., laminated bamboo and timber) are desired for cost-effective sustainable designs. In this regard, multimaterial topology optimization is a promising direction to design sustainable structures while ensuring adequate mechanical performances. A general framework for topology optimization incorporating both conventional isotropic materials and fibrous bio-based materials towards simultaneously enhanced mechanical and sustainability performances is currently underdeveloped.

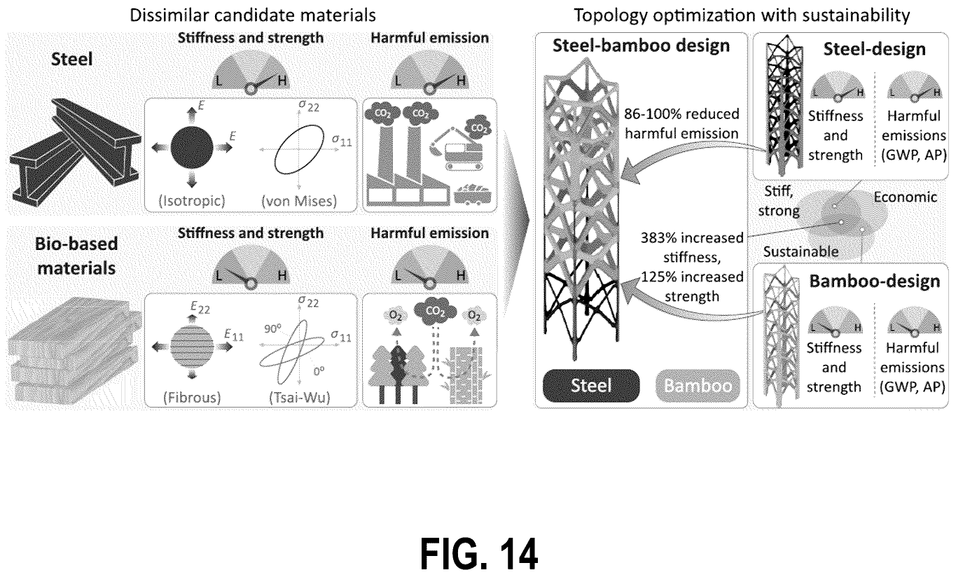

To address the gaps discussed above, the embodiments herein involve a multimaterial, multi-objective topology optimization framework for sustainable structure design that simultaneously harnesses the mechanical, cost, and environmental benefits of conventional and bio-based materials. The novelty of the proposed framework is that it allows the incorporation of both isotropic steel and anisotropic bio-based materials in the formulation to reduce environmental impacts while enhancing the stiffness and strength performances of the optimized design. These embodiments present two formulations for different design scenarios that include the stiffness and environmental impact terms as objective function components or as constraints. Both formulations include a price component in the objective function to reduce the total cost, and local stress constraints to ensure sufficient structural strength to carry the prescribed load. Several presented examples using the two formulations show the importance of including both the strength and environmental effects of the candidate materials in optimization, demonstrate the capability of the framework to harness individual mechanical and environmental advantages from a set of dissimilar materials, and extend the proposed framework to 3D design problems. The motivation and potential impact of these embodiments are summarized in FIG. 14.

The embodiments herein provide a sustainability-orientated multimaterial topology optimization framework that utilizes both metals and biomaterials to design mechanically efficient and cost-effective structures with significantly reduced environmental impacts. In this work, steel is used as a representative metal, and laminated bamboo lumber (hereafter referred to as “bamboo”) and laminated timber (hereafter referred to as “timber”) are used as two representative biomaterials. Steel is modeled as an isotropic material with the von Mises yield criterion, whereas bamboo and timber are considered transversely isotropic (i.e., unidirectional fibers in all laminates) with the Tsai-Wu failure criterion. The von Mises and Tsai-Wu strength parameters in this study represent the corresponding material strengths within their linear elastic ranges. The cost and environmental impacts of different materials are assumed to be linear functions of their corresponding volumes in the design. With these assumptions, the design parameterization, material interpolation schemes, and two sustainability-orientated optimization formulations are provided in the subsequent sections.

While metal and anisotropic biomaterials can be used these embodiments, these methods can be directly adopted to additive manufacturing of composite structures as described in the sections above. Doing so can efficiently and sustainably use, for example, metal (isotropic) and lightweight fiber-composites (anisotropic) in various parts and for 3D design problems.

### A. Design

The embodiments herein simultaneously optimize the geometry of a structure, the distribution of steel and biomaterials, and the local fiber orientations in different biomaterials to achieve sustainable designs with high mechanical performance and low environmental impacts. A discrete fiber orientation approach is used for the biomaterials, where different pre-selected fiber orientations in bamboo and timber are treated as distinct candidate material phases. A multimaterial structure comprising steel and various fiber orientations of different biomaterials is represented using the two-field multimaterial design parameterization.

The density design field ρ(x) determines the material spatial occupancy, and the material design fields ξ^{(k)}(x) where k=1, . . . , N_{ξ} determine the material phase types, respectively, within a design domain Ω(x). The piecewise constant distributions of these design fields are considered for numerical computation. For a design domain discretized in Nₑ elements, ρₑ denotes the design density variable, and

$${ξ}_{e}^{( k )} , k = 1 , … , {N}_{ξ}$$

denote the material design variables for each element e. In the embodiments herein, the total number of material design variables N_{ξ} depends on the total number of material phases Nₘ as N_{ξ}=Nₘ−1 because of the adopted design to physical variable projection scheme.

The embodiments herein also adopt filtering and Heaviside projection for both design density and material variables to obtain a regularized and discrete multimaterial design at the end of optimization. Filtering on the design density variable ρ is applied as

$${\tilde{ρ}}_{e} = \frac{{\sum }_{j ∈ {N}_{e} ( {R}_{ρ} )} w ( {x}_{j} ) {v}_{j} {ρ}_{j}}{{\sum }_{j ∈ {N}_{e} ( {R}_{ρ} )} w ( {x}_{j} ) {v}_{j}} \qquad ( 11 )$$

Where xⱼ is the centroid element j, vⱼ is the corresponding element volume, R_{ρ} is the filter radius for density variable, [symbol] is the neighborhood of element e defined by filter radius R_{ρ}, and w(xⱼ) is the cubic weight function. Here,

$${e}_{} ( {R}_{ρ} ) = \{ j \text{:} ‖ {x}_{j} - {x}_{e} ‖ \leq {R}_{ρ} \}$$

$$And$$

$$w ( {x}_{j} ) = {max ( 0 , 1 - ‖ {χ}_{j} - {χ}_{e} ‖ / {R}_{ρ} )}^{3}$$

Subsequently, the Heaviside projection can be applied on the filtered variable \tilde{ρ} as

$${\overline{ρ}}_{e} = \frac{tan h ( {β}_{ρ} {γ}_{ρ} ) + tan h ( {β}_{ρ} ( {\tilde{ρ}}_{e} - {γ}_{ρ} ) )}{tan h ( {β}_{ρ} {γ}_{ρ} ) + tan h ( {β}_{ρ} ( 1 - {γ}_{ρ} ) )} \qquad ( 12 )$$

Where β_{ρ} and γ_{ρ} are the Heaviside parameters to control the discreteness and threshold of the projection operation, respectively. The filtered and Heaviside projected density variable ρ̅ₑ is the physical density variable that determines the element e to be solid or void with values 1 and 0, respectively. The filtered and Heaviside projected material variables

$${\overline{ξ}}_{e}^{( k )} , k = 1 , … , {N}_{ξ}$$

with filter radius R_{ξ} and Heaviside parameters β_{ξ} and γ_{ξ} can be obtained similarly. A tailored version of the Hypercube-to-Simplex Projection (HSP) can be applied to

$${\overline{ξ}}_{e}^{( k )} , k = 1 , … , {N}_{ξ}$$

to obtain physical material variables

$${\overline{m}}^{( i )} , i = 1 , … , {N}_{m} , wherein {\overline{m}}_{e}^{( i )}$$

represents the physical proportion of the candidate material phase i at element e with

$${\sum }_{i} {\overline{m}}_{e}^{( i )} = 1 .$$

The tailored HSP mapping is given as

$${\overline{m}}_{e}^{( i )} = {\sum }_{j = 1}^{{2}^{( {N}_{m} - 1 )}} {b}_{j}^{( i )} ( {( - 1 )}^{{N}_{m} - 1 + {\sum }_{i = 1}^{m} {c}_{j}^{( i )}} {\prod }_{k}^{{N}_{m} - 1} ( {ξ}_{e}^{- ( k )} + {c}_{j}^{( k )} - 1 ) ) \qquad ( 13 )$$

$$Where i = 1 , … , {N}_{m} - 1 and$$

$${\overline{m}}_{e}^{( {N}_{m} )} = 1 - {\sum }_{i = 1}^{{N}_{m} - 1} {\overline{m}}_{e}^{( i )}$$

$$With$$

$${b}_{j}^{( i )} = \{ \frac{{c}_{j}^{( i )}}{{\sum }_{i = 1}^{{N}_{m} - 1} {c}_{j}^{( i )}} \qquad ( 14 )$$

$$If {\sum }_{i = 1}^{{N}_{m} - 1} {c}_{j}^{( i )} \geq 1 and where {b}_{j}^{( i )} = 0 otherwise . Here , {c}_{j}^{( i )} = \{ 0 , 1 \}$$

is the jth vertex of an (Nₘ−1)-dimensional unit hypercube for the ith candidate material, and

$${b}_{j}^{( i )}$$

is the mapped vertex of (Nₘ−1)-dimensional standard simplex domain.

The proposed framework integrates dissimilar mechanical properties (i.e., stiffness and strength), costs, and environmental impacts of steel and biomaterials into topology optimization. This subsection outlines the interpolation schemes to accommodate these diverse material characteristics in a gradient-based optimization algorithm.

### 1. Stiffness

The embodiments herein may use Solid Isotropic Material with Penalization (SIMP) through density variable ρ̅ₑ combined with a SIMP-like interpolation through physical material variables

$${\overline{m}}_{e}^{( i )} , i = 1 , … , {N}_{m}$$

to obtain the multimaterial interpolated stiffness tensor

$${C}_{e}^{( ξ )}$$

for element e as

$${C}_{e}^{( ξ )} = ( {\overline{ρ}}_{e} , {\overline{m}}_{e}^{( 1 )} , … , {\overline{m}}_{e}^{( {N}_{m} )} ) = [ ε + ( 1 - ε ) {\overline{ρ}}_{e}^{{p}_{ρ}} ] {\sum }_{i = 1}^{{N}_{m}} {( {\overline{m}}_{e}^{( i )} )}^{{p}_{ξ}} {C}_{e}^{( i )} \qquad ( 15 )$$

Where p_{ρ} and p_{ξ} are the penalization parameters associated with density and material variables, respectively, ε is a small number to avoid the numerical singularity, and C⁽ⁱ⁾ is the element stiffness tensor of the ith candidate material phase in the global coordinates. The transversely isotropic stiffness tensors are transformed from fiber coordinate to global coordinate using transformation tensors. For the convenience of numerical computations, this transformation is obtained in the Voigt form (i.e., matrix form) using a transformation matrix T⁽ⁱ⁾ corresponding to material phase i as

$${k}_{e} = {T}^{{( i )}^{- 1}} {\hat{k}}_{e} {T}^{{( i )}^{- T}} \qquad ( 16 )$$

Where kₑ and \hat{k}ₑ are the matrix forms of the element stiffness tensors in global and fiber coordinates, respectively. The matrix \hat{k}ₑ can be constructed from elastic modulus along fiber E_{A}, elastic modulus transverse to the fiber E_{T}, Poisson's ratio along fiber v_{A}, and shear modulus along fiber G_{A}. For isotropic material phase, the element stiffness matrix kₑ is constructed in global coordinates with Young's modulus Eᵢₛₒ and Poisson's ratio vᵢₛₒ, without any transformation. These elasticity parameters are typically obtained from material characterization tests for steel and different biomaterials.

### 2. Strength

These embodiments can use the von Mises yield criterion for the isotropic material steel, and the Tsai-Wu failure criterion for the fibrous transversely isotropic materials bamboo and timber to represent their respective material strengths within linear elastic range. The von Mises yield criterion is expressed as

$${f}^{( vm )} ( σ ) = \frac{{σ}_{vm} ( σ )}{{\overline{σ}}_{iso}} = \frac{\sqrt{\frac{3}{2} s ( σ ) \text{:} s ( σ )}}{{\overline{σ}}_{iso}} \leq 1 \qquad ( 17 )$$

Where σᵥₘ(σ) is the von Mises stress, s(σ) is the deviatoric component of the stress tensor σ, and σ̅ᵢₛₒ is the von Mises stress limit of the isotropic material phase. The transversely isotropic Tsai-Wu failure criterion is expressed as (in the Voigt form) as

$${\dot{f}}^{( tw )} ( \hat{σ} ) = {F}_{ab} {\hat{σ}}_{a} {\hat{σ}}_{b} + {F}_{a} {\hat{σ}}_{a} \leq 1 \qquad ( 18 )$$

Where F_{ab} and Fₐ are the Tsai-Wu material strength coefficients, and \hat{σ}ₐ are the Voigt stress components in fiber coordinates. The Tsai-Wu material strength coefficients can be estimated as

$${F}_{1} = \frac{1}{{X}_{t}} - \frac{1}{{X}_{c}} \qquad ( 19 )$$

$${F}_{2} = \frac{1}{{Y}_{t}} - \frac{1}{{Y}_{c}}$$

$${F}_{11} = \frac{1}{{X}_{t} \cdot {X}_{c}}$$

$${F}_{22} = \frac{1}{{Y}_{t} \cdot {Y}_{c}}$$

$${F}_{12} = - 0.5 \sqrt{{F}_{11} {F}_{22}}$$

$${F}_{66} = \frac{1}{{S}^{2}}$$

Where Xₜ and Yₜ are uniaxial tension strengths along and transverse to fiber, respectively, X_{c} and Y_{c} are uniaxial compression strengths along and transverse to fiber, respectively, and S denotes the shear strength. For a 3D problem, identical properties in the orthogonal directions transverse to the fiber orientations are assumed, i.e., F₃=F₂, F₃₃=F₂₂, F₄₄=F₅₅=F₆₆, F₁₃=F₁₂, and F₂₃=−0.5\sqrt{F₂₂F₃₃}. For consistent penalization between von Mises and Tsai-Wu criteria-based stress constraints, the embodiments herein use the safety-factor based form of Tsai-Wu failure criterion given by

$${f}^{( tw )} ( \hat{σ} ) = \frac{2 A ( \hat{σ} )}{\sqrt{{B}^{2} ( \hat{σ} ) + 4 A ( \hat{σ} )} - B ( \hat{σ} )} \leq 1 \qquad ( 20 )$$

Where A(\hat{σ})=F_{ab}σₐσ_{b} and B(\hat{σ})=Fₐσₐ. The minimum value of A(\hat{σ}) can be set to an arbitrarily low value (e.g., 1×10⁻¹²) to avoid numerical singularity.

The dissimilar material strength properties of steel and different biomaterials, represented by different yield functions in Equations 17 and 20, are incorporated in topology optimization using a multimaterial yield function interpolation scheme. In this scheme, a SIMP-like interpolation of yield functions through physical material variables m̅⁽ⁱ⁾, i=1, . . . , Nₘ obtains the interpolated yield function

$${f}_{e}^{( ξ )} ( {\overline{m}}_{e}^{( 1 )} , … , {\overline{m}}_{e}^{( {N}_{m} )} , {σ}_{e}^{( 1 )} , … , {σ}_{e}^{( {N}_{m} )} ) {\sum }_{1}^{{N}_{m}} {( {\overline{m}}_{e}^{( i )} )}^{{p}_{{f}_{ξ}}} {f}^{( i )} ( {σ}_{e}^{( i )} ) Where {σ}_{e}^{( i )} := {C}^{( i )} {ϵ}_{e} and {f}^{( i )} ( σ ) \qquad ( 21 )$$

are the stress state and yield function respectively corresponding to ith candidate material phase for element e, ϵₑ is the strain field for element e, and p_{ƒ}_{_{ξ}} is penalization parameter. Using the interpolated yield function in Equation 21, the yield function measure (YFM) for an element e can be interpreted as

$${Θ}_{e} ( {\overline{ρ}}_{e} , {\overline{m}}_{e}^{( i )} , … , {\overline{m}}_{e}^{( {N}_{m} )} ) = [ ε + ( 1 - ε ) {\overline{ρ}}_{e}^{{p}_{ρ}} ] {f}_{e}^{( ξ )} ( {\overline{m}}_{e}^{( 1 )} , … , {\overline{m}}_{e}^{( {N}_{m} )} ) \leq 1 \qquad ( 22 )$$

Which denotes material stress state exceeding material strength, i.e., local failure with YFM values exceeding 1. For an isotropic material, this YFM (Θ) is equivalent to the von Mises stress normalized with corresponding von Mises strength.

Concrete may not have the exact von Mises strength criterion used above. However, the appropriate criterion (i.e., the yield function) can be included in the same methodology to account for concrete.

### 3. Environmental Impact and Cost

The embodiments herein consider two environmental impact categories, global warming potential (GWP) and acidification potential (AP). Other impacts such as eutrophication potential (EP), ozone depletion potential (ODP), and photochemical ozone creation potential (POCP) could also be considered in the optimization formulations based on specific design requirements.

GWP indicates the warming induced by the emission of greenhouse gases, whereas AP estimates the damage in building materials, lakes, rivers, and living organisms due to the increased concentration of hydrogen ions in the environment. The sustainability-oriented optimization framework aims to significantly reduce these environmental impacts by systematically incorporating different bio-based material phases into the optimization of engineering structures. In this work, the environmental impacts of different materials are assumed as linear functions of their corresponding volumes in the multimaterial structure. The normalized total environmental impact for a multimaterial structure can be estimated as

$$\overline{{I}_{j}} ( {\overline{ρ}}_{e} , {\overline{m}}_{e}^{( 1 )} , … , {\overline{m}}_{e}^{( {N}_{m} )} ) = {\sum }_{e = 1}^{{N}_{e}} {\overline{I}}_{j , e} = {\sum }_{e = 1}^{{N}_{e}} {\sum }_{i = 1}^{{N}_{m}} \frac{{\overline{ρ}}_{e} {\overline{m}}_{e}^{( i )} {α}_{j}^{( i )} {ν}_{e}}{\vert {min}_{i = 1 , … , {N}_{m}} \{ {α}_{j}^{( i )} \} \vert {ν}_{e}} \\ Where j = \{ gwp , ap \} . The term {α}_{j}^{( i )} \qquad ( 23 )$$

is the per unit volume environmental impact corresponding to impact category j for material phase i, and vₑ is the element volume. Here, minimum operator for normalization is used to avoid potential numerical problems in MMA optimizer with very small values, as the environmental impacts per volume from steel are often significantly higher than bio-based materials. However, using the maximum operator for normalization is also viable with proper scaling of the constraint functions in the MMA optimizer.

While structures designed using bamboo or timber alone may be an intuitive choice for better environmental performance, they may also incur considerable costs that compete with their sustainability benefits. Biomaterials often need to be used in high volumes compared to steel to provide comparable structural strength and stiffness for safe operation, thereby reducing the available free volume for practical use. Furthermore, different bio-based materials may have significantly varied costs depending on their procurement and processing practices, which may affect their cost feasibility for industry applications. Therefore, in addition to the environmental considerations, the embodiments herein incorporate the cost impacts of different materials in the proposed formulations to promote cost-effective designs while prioritizing sustainability. Similar to Equation 23, the normalized cost impact or price for a multimaterial structure is expressed as

$$\overline{P} ( {\overline{ρ}}_{e} , {\overline{m}}_{e}^{( 1 )} , … , {\overline{m}}_{e}^{( {N}_{m} )} ) = {\sum }_{e = 1}^{{N}_{e}} {\overline{P}}_{e} = {\sum }_{e = 1}^{{N}_{e}} {\sum }_{i = 1}^{{N}_{m}} \frac{{\overline{ρ}}_{e} {\overline{m}}_{e}^{( i )} {α}_{price}^{( i )} {ν}_{e}}{{min}_{i = 1 , … , {N}_{m}} \{ {α}_{price}^{( i )} \} {ν}_{e}} Where {α}_{price}^{( i )} \qquad ( 24 )$$

is the price of material phase i per unit volume.

### B. Optimization Formulations

In this section, two sustainability-oriented topology optimization formulations are presented that incorporate various structural performances, such as structural stiffness and strength, as well as their cost and environmental impacts, either as objective function components or constraints to achieve stiff, strong, low-cost, and sustainable structures. Formulation 1 is more suitable for design problems that have predetermined upper limits for environmental impacts. Formulation 2 is more suitable for design problems with predetermined requirements for mechanical performances.

### 1. Formulation 1

Formulation 1 minimizes a weighted sum of total price and structural compliance subjected to environmental impact constraints and local stress constraints. In this case, the goal is to obtain most cost-conscious and stiff design while satisfying the given sustainability and strength requirements. A volume constraint is also added to ensure adequate free space for human use or other miscellaneous purposes. The proposed formulation 1 is given by

$${min}_{ρ , {ξ}^{( 1 )} , … , {ξ}^{( {N}_{ξ} )}} J ( ρ , {ξ}^{( 1 )} , … , {ξ}^{( {N}_{ξ} )} , U ) = w \overline{P} + ( 1 - w ) \overline{C} Such that \\ {g}_{e}^{( s t r e s s )} ( ρ , {ξ}^{( 1 )} , … , {ξ}^{( {N}_{ξ} )} , U ) = {Θ}_{e} - 1 \leq 0 {g}_{e}^{( v o l )} ( ρ ) = V - {V}^{*} \leq 0 {g}_{e}^{( e n v )} ( ρ , {ξ}^{( 1 )} , … , {ξ}^{( {N}_{ξ} )} ) = \overline{{I}_{i}} - {\overline{{I}_{i}}}^{*} \leq 0 With \\ K ( ρ , {ξ}^{( 1 )} , … , {ξ}^{( {N}_{ξ} )} ) U = {F}^{e x t} Where e = 1 , … , {N}_{e} , {ρ}_{e} ∈ [ 0 , 1 ] , {ξ}_{e}^{( k )} ∈ [ 0 , 1 ] , i = \{ gwp , ap \} , and \\ k = 1 , … , {N}_{ξ} . Also \overline{C} = \frac{{( {F}^{e x t} )}^{T} U ( ρ , {ξ}^{( 1 )} , … , {ξ}^{( {N}_{ξ} )} )}{{C}^{0}} \qquad ( 25 )$$

is the normalized end-compliance with C⁰ being the end-compliance of the mixed-material initial design guess having ρₑ=0.5 and ξ⁽¹⁾, . . . , ξ^{(N}^{_{ξ}}⁾=0.25, P̅ is the normalized price or cost impact for the structure from Equation 24, w∈[0,1] is a weight factor in the objective, Θ is the YFM from Equation 22, and

$$V = \frac{{\sum }_{e = 1}^{{N}_{e}} {\overline{ρ}}_{e} {ν}_{e}}{{\sum }_{e = 1}^{{N}_{e}} {ν}_{e}}$$

is the total volume fraction with upper limit V*, Īᵢ is the normalized environmental impact i with upper limit

$${\overline{{I}_{i}}}^{*} , K ( ρ , {ξ}^{( 1 )} , … , {ξ}^{( {N}_{ξ} )} )$$

is the global stiffness matrix obtained from the interpolated stiffness Equation 15. U and F^{ext} are the global displacement vector and the global external force vector, respectively. In case of multiple environmental impact constraints, these embodiments can use the KS aggregation function as

$${g}_{e}^{( e n v )} ( ρ , {ξ}^{( 1 )} , … , {ξ}^{( {N}_{ξ} )} ) = {τ}_{K S} [ ( \overline{{I}_{i}} - {\overline{{I}_{i}}}^{*} ) ] \leq 0 \\ With \\ {τ}_{K S} [ ( \overline{{I}_{i}} - {\overline{{I}_{i}}}^{*} ) ] = {max}_{i = gwp , ap} [ ( \overline{{I}_{i}} - {\overline{{I}_{i}}}^{*} ) ] + \frac{1}{{β}_{K S}} log ( {\sum }_{i} exp ( {β}_{K S} ( ( \overline{{I}_{i}} - {\overline{{I}_{i}}}^{*} ) - {max}_{i = gwp , ap} [ ( \overline{{I}_{i}} - {\overline{{I}_{i}}}^{*} ) ] ) ) ) \qquad ( 26 )$$

Where β_{KS}∈(1, ∞] is a smoothness parameter. When all environmental impacts are assumed linear functions of material volumes, the KS aggregation function selects only the most dominant environmental constraint throughout the optimization, which can also be estimated beforehand to eliminate the aggregation operation and associated computations. However, this aggregation approach can be particularly useful when dealing with multiple environmental impacts that are nonlinear functions of material volumes.

As these embodiments assume linear relations between material volumes and associated environmental impacts and costs, the volume constraint may become redundant depending on the set upper limits of different environmental impacts. However, the volume constraint is kept to restrict the predominant use of bio-based materials at the cost of available user space. The absence of usable space may incur additional costs in practice beyond the direct cost of the used materials, which is not accounted for in the proposed formulation. While applying a strict environmental constraint can restrict bio-based material volume usage, it may lead to designs without any steel materials, resulting in significantly inferior mechanical performances. Furthermore, a volume constraint can also prevent unnecessary use of bio-based materials with negative environmental impacts. Further, some environmental impacts and costs are expected to be nonlinear functions of volumes, depending on several factors, including procurement, processing, transportation, and installation.

### 2. Formulation 2

Formulation 2 minimizes a weighted sum of cost and environmental impacts with structural compliance constraint, volume constraint, and local stress constraints. In this case, the goal is to reduce the cost and environmental impacts as much possible while ensuring sufficient structural stiffness and strength. The proposed formulation 2 is given by

$${min}_{ρ , {ξ}^{( 1 )} , … , {ξ}^{( {N}_{ξ} )}} J ( ρ , {ξ}^{( 1 )} , … , {ξ}^{( {N}_{ξ} )} ) = {w}_{1} \overline{P} + {w}_{2} {\overline{I}}_{g w p} + {w}_{3} {\overline{I}}_{a p} \\ Such that \\ {g}_{e}^{( s t r e s s )} ( ρ , {ξ}^{( 1 )} , … , {ξ}^{( {N}_{ξ} )} , U ) = {Θ}_{e} - 1 \leq 0 \\ {g}_{e}^{( v o l )} ( ρ ) = V - {V}^{*} \leq 0 \\ {g}_{e}^{( c o m p l i a n c e )} ( ρ , {ξ}^{( 1 )} , … , {ξ}^{( {N}_{ξ} )} , U ) = \overline{C} - {\overline{C}}^{*} \leq 0 \\ With \\ K ( ρ , {ξ}^{( 1 )} , … , {ξ}^{( {N}_{ξ} )} ) U = {F}^{e x t} \\ Where e = 1 , … , {N}_{e} , {ρ}_{e} ∈ [ 0 , 1 ] , {ξ}_{e}^{( k )} ∈ [ 0 , 1 ] , i = \{ gwp , ap \} , and \\ k = 1 , … , {N}_{ξ} . Also {w}_{1} + {w}_{2} + {w}_{3} = 1 and {w}_{1} , {w}_{2} , {w}_{3} ∈ [ 0 , 1 ] \qquad ( 27 )$$

are weight factors for different objective function components, and C̅* is the allowable upper limit for normalized structural compliance. The other variable descriptions are same as in the formulation 1.

In both formulations, the stress constraints are handled using the Augmented Lagrangian (AL) method, which preserves the local nature of stress constraints. In the AL approach, the local stress constraints in the objective are augmented to form a sub-problem, which iteratively approaches the solution of the original problem. Additionally, these embodiments can use the method of moving asymptotes (MMA) as a gradient-based optimizer.

### C. Numerical Examples

This section presents three design examples with the proposed formulations above to demonstrate sustainability-oriented multimaterial designs. The first example illustrates the sustainability benefits of incorporating biomaterials in topology optimization, while ensuring sufficient load capacity with appropriate anisotropic stress constraints. The second example demonstrates efficient utilization of individual mechanical and environmental benefits of various candidate materials according to different design requirements. The third example extends the proposed framework to a three-dimensional problem, and compares the mechanical, cost, and environmental performances of steel-biomaterial multimaterial design with single material designs. The three examples together demonstrate the benefits of the proposed multimaterial topology optimization framework incorporating mechanical, cost, and sustainability considerations.

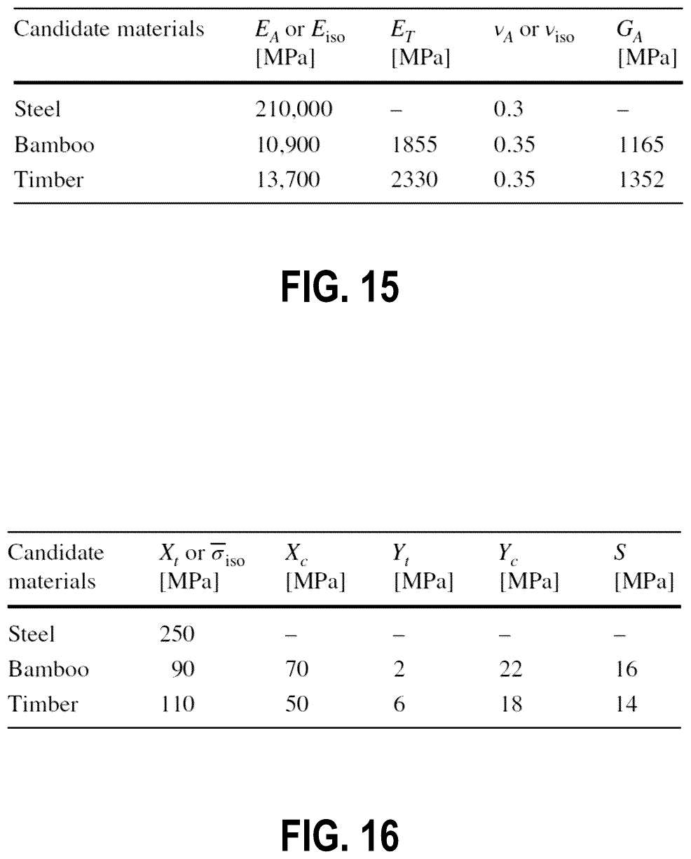

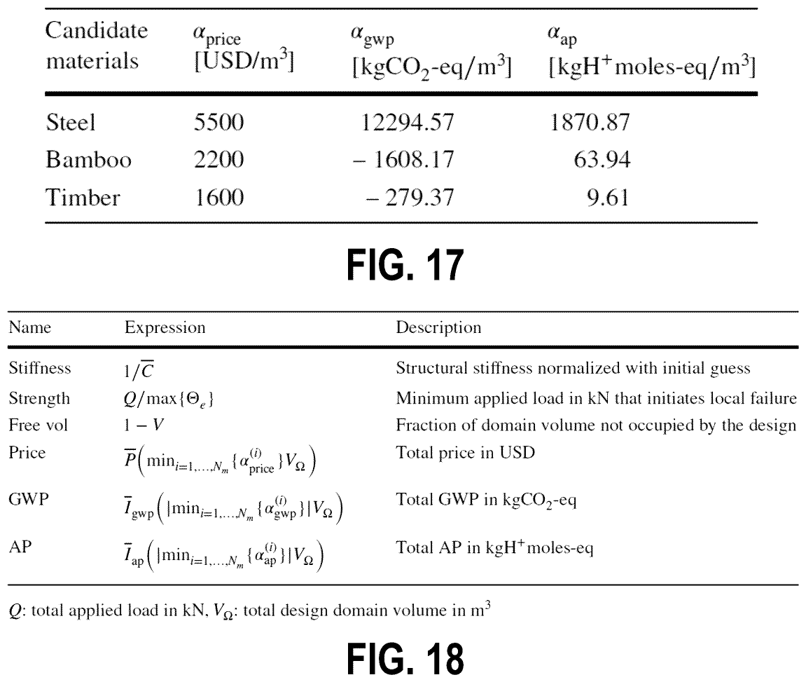

All presented examples use the stiffness parameters from FIG. 15, the strength parameters from FIG. 16, and the cost and environmental parameters from FIG. 17 for steel, bamboo, and timber candidate materials. Each example also compares the optimized designs from different design cases in terms of different performance measures. FIG. 18 lists the expressions and descriptions of these different performance measures related to various mechanical, cost, and environmental aspects. The environmental parameter for GWP in Table 3 is negative in case of the bamboo and timber, as they consume a large amount of CO2 during their growth phase. However, depending on the scope of the life cycle analysis period, positive GWP for bio-based material is also reported in some studies.

In these embodiments, the following continuation strategy for the optimization parameters is used. A constant p_{ρ}=3 is used throughout the optimization, p_{ξ}=p_{ƒ}_{_{ξ}}=β_{ρ}=β_{ξ}=1 as the initial values for first 160 iterations. Then the parameters p_{ξ} and p_{ƒ}_{_{ξ}} are increased from 1 to 4 with increments of 0.5 every 100 iterations. After p_{ξ}=p_{ƒ}_{_{ξ}}=4, β_{ρ} and β_{ξ} are increased from 1 to 32 by doubling them every 60 iterations. Then the parameter p_{ƒ}_{_{ξ}} is decreased gradually from 4 to 1 in 500 iterations to further reduce material mixing from the relaxation of interpolated yield surface, i.e., overestimation of material strengths. After p_{ƒ}_{_{ξ}} is reduced to 1, the optimization is terminated either after 60 steps, or a prescribed tolerance 0.005 is satisfied for the stress constraints, whichever happens earlier.

1. Beam Optimization with Environmental Impact and Material Strength

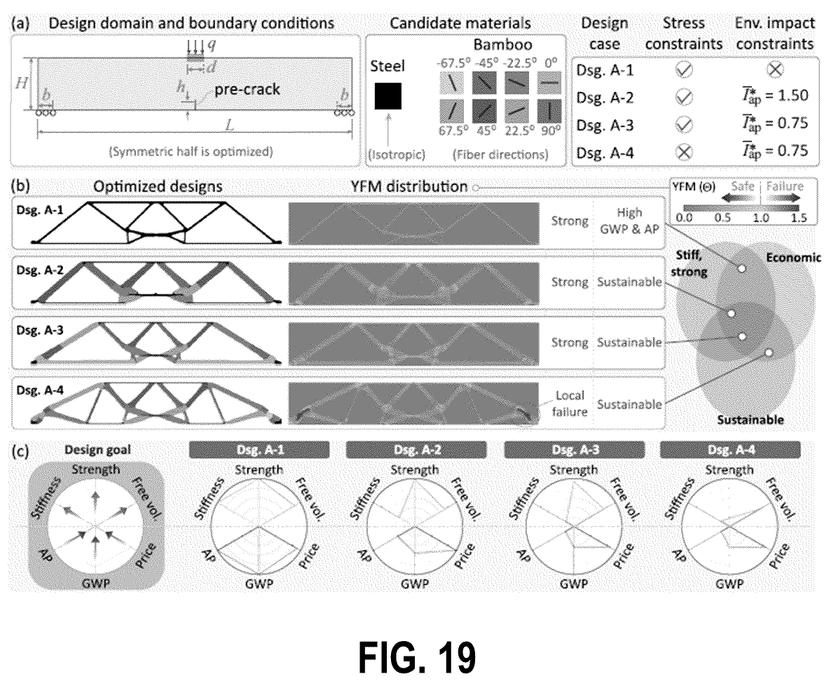

This example demonstrates the sustainability benefits of utilizing biomaterials with low environmental impacts in topology optimization. It also exhibits the benefit of incorporating appropriate anisotropic stress constraints for such fibrous biomaterials. FIG. 19 shows the design domain and boundary conditions, the candidate materials, and the four design cases to optimize. The design domain is an MBB beam with a stress-sensitive pre-crack. The candidate materials include steel and eight equispaced fiber orientations of bamboo, with material properties from FIGS. 15-17. The four design cases correspond to different combinations of environmental impact and stress constraints while using the formulation 1.

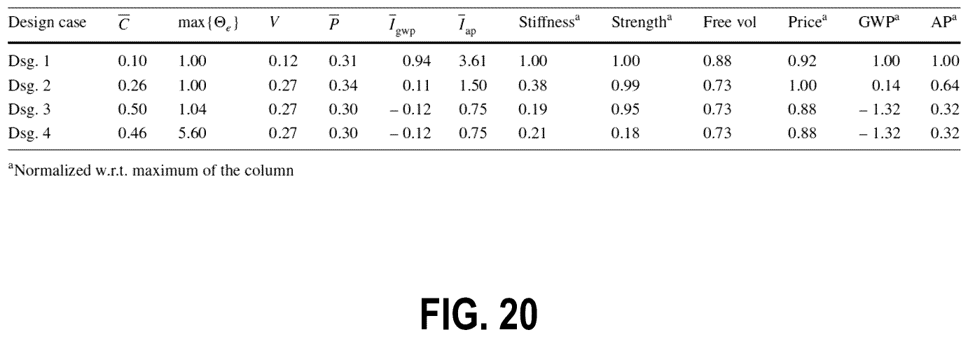

All design cases, i.e., Dsg. A-1 to Dsg. A-4, use maximum volume fraction V*=0.3, weight factor w=0.3, and filter radii R_{ρ}=R_{ξ}=0.5 m. Dsg. A-1 does not include any environmental constraint, whereas Dsg. A-2 to Dsg A-4 includes environmental constraints with decreasing allowable limit of Īₐₚ*. All design cases except Dsg. A-4 includes stress constraints. The optimized designs for these four design cases are shown in FIG. 19 part b, along with their respective YFM distribution plots. The normalized mechanical, cost, and environmental performances of the optimized designs are listed in FIG. 20 and summarized FIG. 19 part c.

Dsg. A-1 results in a steel-only design, as a higher stiffness-to-price ratio of steel compared to bamboo makes it more preferable to the optimizer because of the weighted sum objective of compliance and price. While predominant use of steel in Dsg. A-1 enables highest stiffness and strength per unit structural volume, it also results in highest GWP and AP among all design cases. Therefore, the superior mechanical performance in steel design Dsg. A-1 comes at a significant cost to the environment.

In contrast, including environmental impact constraints in Dsg. A-2 and Dsg. A-3 results in steel-bamboo multimaterial designs with 60-80% reduction in AP. The environmental constraint for AP promotes more bamboo usage in the optimized designs, which also results in lower GWP. While these two design cases have lower structural stiffness and free volume compared to Dsg. A-1, they still offer the same structural strength, i.e., load carrying capacity as Dsg. A-1 at the expense of similar cost. Therefore, Dsg. A-2 and Dsg. A-3 are sustainable and cost-effective alternatives to Dsg. A-1 while ensuring safe mechanical operation for the prescribed load. The structural stiffness in steel-bamboo multimaterial designs may be further improved, if necessary, by using a higher allowable limit for the environmental impacts.

Despite bamboo having lower material strength compared to steel, the bamboo-dominated designs Dsg. A-2 and Dsg. A-3 achieves same structural strength as the steel-only design Dsg. A-1. This improvement in mechanical performance is attributed to the stress constraints, which appropriately incorporate the anisotropic and isotropic material strengths in topology optimization. In Dsg. A-4, the environmental constraint enables a bamboo-dominated design with significant reduction in AP and GWP compared to Dsg. A-1. However, exclusion of the material strength information, i.e., stress constraints in Dsg. A-4 allows the local stress to go beyond material strength limits as indicated by YFM (Θ) values exceeding 1. The corresponding YFM plot shows local failure with maximum YFM≈5.6, which implies a 5.6 times lower reduced load carrying capacity compared to the other design cases with maximum YFM≈1. Hence, Dsg. A-4 is sustainable, but not strong enough to withstand the prescribed load without local material failure. The advantage of including stress constraints is particularly evident in Dsg. A-3, as it achieves significantly higher structural strength compared to Dsg. A-4 while having similar stiffness, cost, and environmental performances.

Furthermore, the weighted sum of compliance and price objective function promotes stiff and cost-concious structures for all design cases. For example, the steel-dominated structure (Dsg. A-1) uses less than 50% of allowable volume fraction to reduce cost, and the bamboo-dominated structures (Dsg. A-2, Dsg. A-3, and Dsg. A-4) align the fiber orientations along load paths to increase structural stiffness. In the steel-bamboo multimaterial designs with environmental constraint, a low amount of steel is efficiently utilized at the stress-intensive notch, primary load-bearing members, and support regions to enhance structural stiffness and strength.

2. Bridge Optimization with Different Mechanical and Environmental Designs

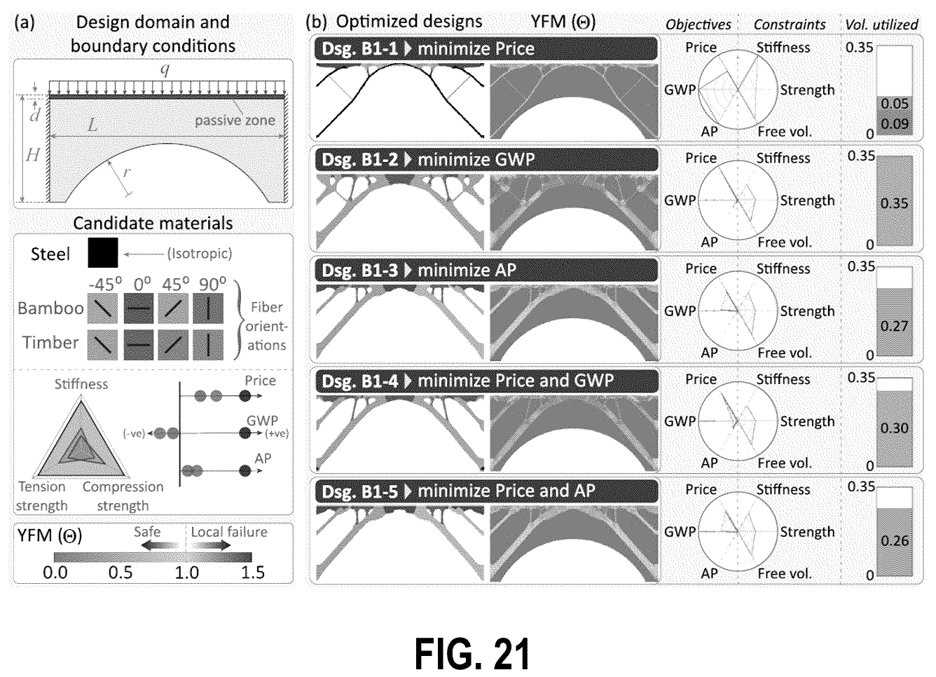

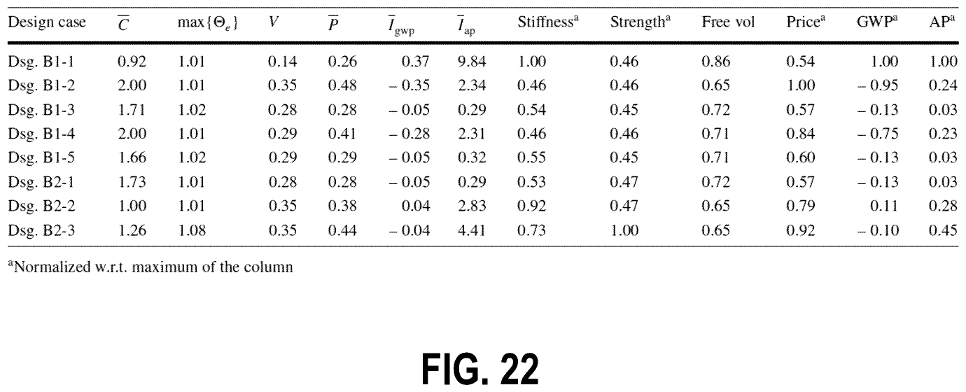

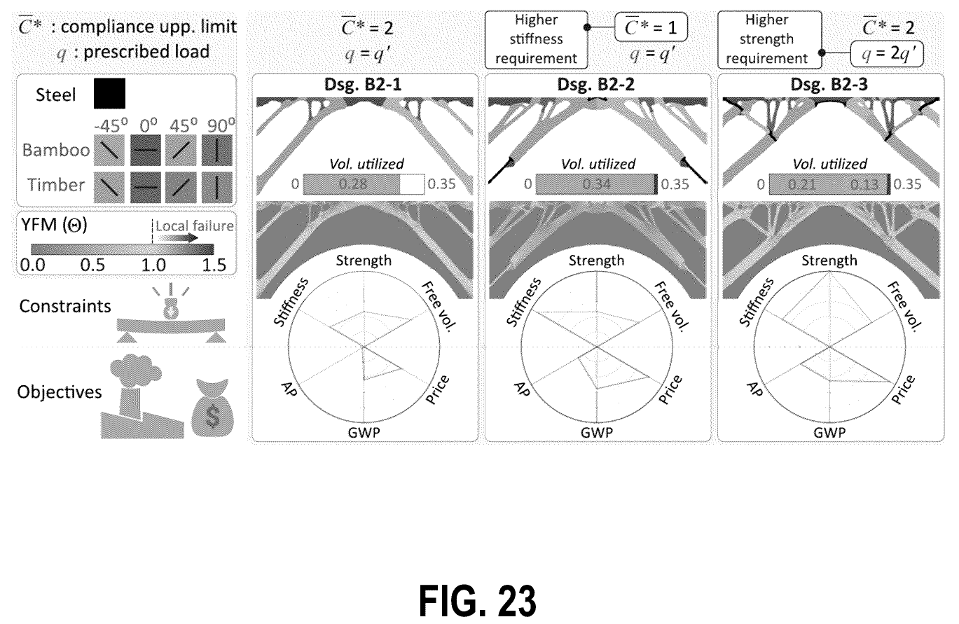

This example highlights the capability of the proposed framework to handle a diverse set of candidate materials and harness their unique advantages according to different design requirements from multiple aspects, including stiffness, asymmetric tension-compression strength, market price, and different environmental impacts. Two sets of design cases use formulation 2. In FIG. 21, Dsg. B1-1 to Dsg. B1-5 have varying weights for price, GWP, and AP in the objective function, whereas FIG. 23 includes Dsg. B2-1 to Dsg. B2-3 with varying stiffness and strength requirements. For both sets of design cases, FIG. 21 part a shows the design domain with load and boundary conditions, and the candidate material phases with a qualitative comparison of their key material properties obtained from FIGS. 15-17. A comparison of different performance measures for the optimized designs is listed in FIG. 22.

FIG. 21 part b shows the result of first design set with five design cases Dsg. B1-1 to Dsg. B1-5 that use different objective functions with varying weights for price, GWP, and AP. It also includes the corresponding YFM plots, radial charts to compare different components of objective functions and constraints (i.e., mechanical, cost, and environmental performances) from FIG. 22, and the different material volumes in the optimized designs. For this design set, a maximum volume limit V*=35%, maximum normalized compliance limit C̅*=2, and filter radii R_{ρ}=R_{ξ}=0.8 m are used.

For Dsg. B1-1, minimizing only price without considering any environmental impacts results in a steel-dominated design despite the steel having highest price per volume. In this case, the optimizer reduces total price by reducing the overall structural volume. As steel has much higher stiffness and strength per volume compared to bamboo and timber, a relatively lower amount of steel becomes sufficient to achieve the required stiffness and strength (i.e., compliance and stress constraints) for the design. In contrast, minimizing only GWP leads to a bamboo-only design, and minimizing only AP leads to timber-dominated designs for Dsg. B1-2 and Dsg. B1-3, respectively, as bamboo offers the most negative GWP and timber offers the least AP among the three candidate materials. This comparison indicates that including environmental impact in the objective function promotes bio-based material in the design, and the proposed framework can choose suitable bio-based materials from different candidates according to the desired sustainability goals.

Dsg. B1-4 minimizes the sum of price and GWP with equal weights, and Dsg. B1-5 minimizes the sum of price and AP with equal weights. In general, minimizing the weighted sum of price and any one of the two environmental impacts leads to a similar design as only minimizing the individual environmental impacts, as the reductions in environmental impacts are dominant compared to the reduction in price for per unit volume of steel replaced by any of the bio-based materials. For example, Dsg. B1-5 achieves almost the same timber-only design as Dsg. B1-3, as timber has both the lowest price and the lowest AP per volume. This result is expected because a timber-only design with the lowest AP, while ensuring required stiffness and strength, essentially uses the lowest volume of timber resulting in the lowest price. However, Dsg. A4 with a price component in objective uses less volume of bamboo compared to Dsg. B1-2. Since bamboo has a negative GWP per volume, the optimizer prefers to increase the bamboo volume in Dsg. B1-2 when the objective is minimizing only GWP. In this case, more bamboo is used in excess than required to satisfy the desired stiffness and strength requirements. Hence, this comparison demonstrates that including price in the objective function along with environmental impacts can contribute to overall sustainability while ensuring minimal material usage.

Notably, all four designs with environmental components in the objective (i.e., Dsg. B1-2 to Dsg. B1-5) have ≈50% reduced stiffness and same strength as Dsg. B1-1. However, they achieve reduction of ≈87-195% in GWP and ≈76-97% in AP, while having only 11% increased price for timber structures and 86% increased price in bamboo structures. Higher costs of bamboo-dominated designs are attributed to their higher per-volume price, which may occur because of the wide variation in the procurement and processing practices for different bio-based materials.

In the following, the effect of increased stiffness and strength requirements while having both price and environmental components in the objective function are investigated. A reference case Dsg. B2-1 is assumed with applied load magnitude and compliance constraint same as in FIG. 21, and compare it with two different design scenarios Dsg. B2-2 and Dsg. B2-3 with increased stiffness and strength requirements, respectively. All three cases are optimized with the same objective weight factors, w₁=0.2, w₂=0.4, and w₃=0.4 corresponding to price, GWP, and AP, respectively. Dsg. B2-2 uses a compliance upper limit half that of Dsg. B2-1, and Dsg. B2-3 uses a load magnitude double that of Dsg. B2-1. Other optimization parameters including maximum volume fractions and filter radii are the same as in FIG. 21. FIG. 23 compares the optimized designs for these three design scenarios, along with a summary of their mechanical, cost, and environmental performances from FIG. 22.

Dsg. B2-1 shows an optimized timber-only structure, chosen for its lower cost and environmental impacts among the three candidate materials. However, when stricter stiffness requirements are imposed using a more strict compliance constraint in the case Dsg. B2-2, a multimaterial design that combines steel and timber is favored, albeit with an increase in AP. The increase in GWP from added steel is mitigated by the use of additional timber, which has a negative GWP per volume. Dsg. B2-3 is optimized with a higher magnitude of applied load while satisfying the respective material yield criteria. This necessitates a higher strength requirement for the design, and the optimizer prefers a steel-bamboo-timber multimaterial design while introducing bamboo in members with the most compression stress. Despite having slightly lower stiffness, bamboo is preferred instead of using more timber because bamboo not only offers higher compression strength compared to timber, but also offers more a negative GWP that offsets the AP and price increase by adding more material volume. These comparisons illustrate how the proposed formulation enables the optimal selection of materials tailored to specific design requirements from a range of candidates with various competing advantages.

### 3. 3D Designs

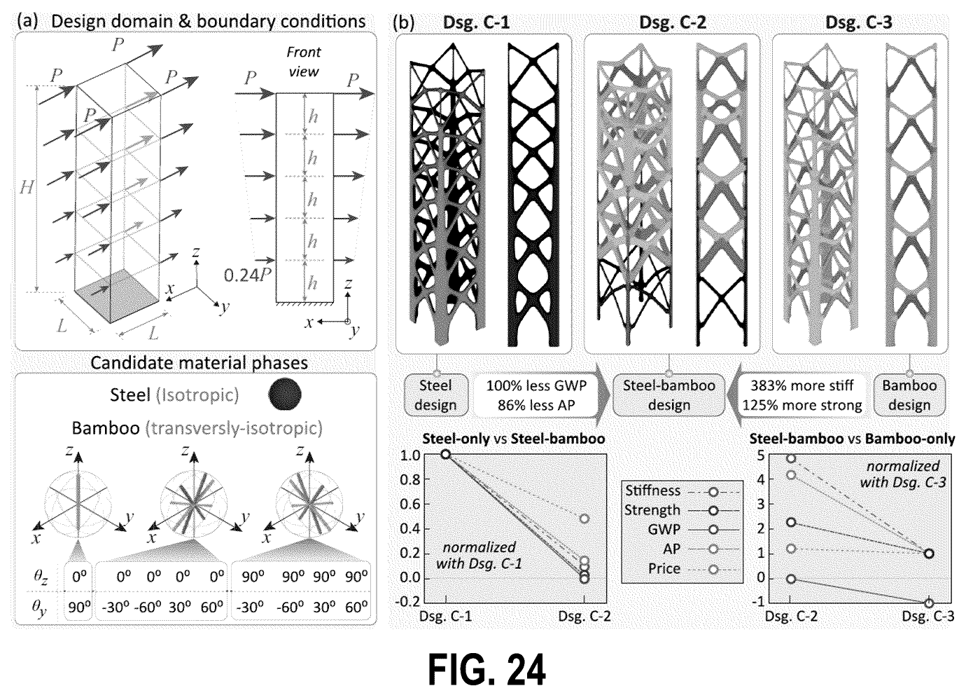

This example uses a 5-story tower design domain with lateral loads along the x-axis, as shown in FIG. 24. The lateral wind load is maximum at the top, and decreases at each floor by a constant factor. Diagonal and x-y symmetry filters are used on both density and material variables to enable a symmetric design that can have similar performance if wind load direction changes along the y-axis. The candidate material phases (FIG. 24 part a) include isotropic steel, and 9 different fiber orientations of transversely isotropic bamboo. Three design cases are considered, namely Dsg. C-1, Dsg. C-2, and Dsg. C-3, with formulation 1, to illustrate how steel-bamboo multimaterial design can achieve a balanced performance in both mechanical and environmental aspects, which is unlikely with single-material steel or bamboo designs. All three design cases are optimized with weight factor w=0.3 for price, a maximum volume limit V*=0.08, and filter radii R_{ρ}=R_{ξ}=0.8 m. No environmental impact constraints are used for Dsg. C-1 to promote single-material steel design, whereas GWP and AP impact constraints have upper limits

$${\overline{I}}_{g w p}^{*} = - 0 \text{.08} and {\overline{I}}_{a p}^{*} = 0.08 ,$$

respectively to promote single-material bamboo design for Dsg. C-3.

In Dsg. C-2, GWP and AP impact constraints have upper limits

$${\overline{I}}_{g w p}^{*} = 0. and {\overline{I}}_{a p}^{*} = 0.36 ,$$

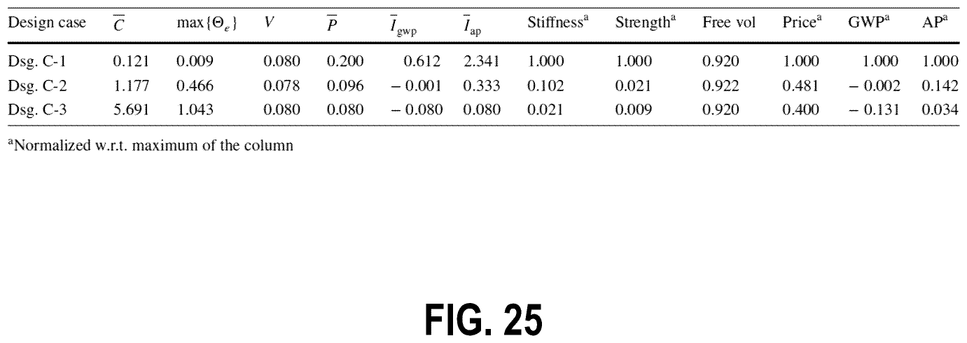

respectively, to promote a multimaterial steel-bamboo zero-carbon design. FIG. 24 part b shows the optimized designs, and FIG. 24 part c compares different performance measures corresponding to the three design cases. The different performance measures for the optimized designs are also listed in FIG. 25.

All of the designs use the entire allowable volume fraction 0.08. For the same material volume, the steel-only design Dsg. C-1 is the mechanically superior design with ≈4619% higher stiffness and ≈1072% higher strength compared to the bamboo-only design, Dsg. C-3. However, Dsg. C-3 is the most environmentally sustainable design with ≤113% reduced GWP and ≈97% lower AP compared to Dsg. C-1. Importantly, the bamboo-only design Dsg. C-3 is a carbon-negative design with a negative total GWP, which is impossible to achieve using any steel-only design even with very low material usage for a similar level of mechanical performance. In contrast, further improvement of mechanical performance in bamboo-only design for the given volume restriction is unlikely, as Dsg. C-3 already shows efficient use of bamboo members with optimized fiber directions aligned along stress paths. Therefore, both single-material steel and bamboo designs come with their distinct advantages and limitations in terms of mechanical and sustainability performance.

In Dsg. C-2, the proposed framework enables a steel-bamboo multimaterial design that achieves a compromise between mechanical and sustainability performances. Compared to the steel-only design Dsg C-1, it exhibits an impressive 100% reduction in GWP and 86% reduction in AP in the steel-bamboo hybrid design Dsg. C-2. At the same time, the Dsg. C-2 improves the stiffness and strength by 383% and 125%, respectively, compared to bamboo-only design Dsg. C-3. In Dsg. C-2, the optimizer efficiently uses the bamboo members mostly in the low-stressed cross-bracings and the upper regions of the four columns, whereas steel is utilized only at the high-stressed lower regions of the cross-bracings and four primary load-bearing columns. Furthermore, predominant use of bamboo members (95% of the utilized total volume) in Dsg. C-2 allows it to achieve 125-383% higher mechanical performance compared to the bamboo-only design Dsg. C-3 at the cost of only 20% higher price. Therefore, this example demonstrates that the steel-bamboo multimaterial designs can achieve a cost-effective compromise between mechanical and environmental performances according to design requirements, which is difficult with single-material steel or bamboo designs.

### D. Fabrication

A structure composed of both mineral-based materials (such as steel, aluminum, or concrete) and biodegradable materials (such as bamboo or lumber) can be manufactured through a process that begins with a digital design such as those that are the output of the optimization frameworks discussed above. This design is a two-dimensional or three-dimensional numerical representation, such as a CAD model, mesh, or voxel-based structure, which includes data specifying the type of material to be used in each region of the structure. Output of the numerical methods described herein may include such a numerical representation.

The manufacturing process may include parsing the digital file to identify the material mappings, effectively segmenting the structure into subcomponents or manufacturing tasks according to material type. Once parsed, the mineral-based and biodegradable portions are fabricated separately using processes suited to each material. For mineral-based components, subtractive techniques such as milling or casting may be used, as well as additive techniques like 3D printing. For biodegradable components, fabrication may involve automated woodworking, laser or other forms of cutting, or even additive processes such as filament extrusion with plant-based polymers or layer-by-layer composite layup methods.

Connection strategies between material types may include mechanical interlocks (e.g., dovetail or mortise-and-tenon joints), structural fasteners, hybrid framing elements, or the use of compatible adhesives. In some cases, a neutral or composite material such as fiber-reinforced polymer may serve as a transitional element between incompatible materials, ensuring load transfer and dimensional stability.

Assembly of the structure can occur in several ways, depending on scale and use case. Components may be integrated manually or robotically at a centralized facility or assembled on-site from prefabricated modules. In other cases, sequential or layered construction methods are used, where one material type is embedded into or deposited around the other—such as pouring concrete into a form containing prepositioned bamboo supports, or vice versa. In some possible implementations, hybrid additive manufacturing systems may be used, where multiple print heads or deposition modules alternate between mineral and biodegradable material deposition according to the digital design, enabling continuous multi-material fabrication within a single build cycle.

### E. Example Operations

As used herein, the terms “high-carbon” and “low-carbon” material types are non-limiting classifications that refer generally to the relative environmental impact of materials, particularly in terms of their carbon content or carbon-equivalent emissions. In some embodiments, high-carbon materials are those with a carbon level above a threshold value, and low-carbon materials are those with a carbon level below that threshold. The threshold value may vary depending on context, material availability, lifecycle assessment methodologies, or other standards. Carbon levels may be quantified in terms of total greenhouse gas emissions associated with material production, usage, and disposal, including contributions to global warming or climate change. In certain implementations, high-carbon materials may include non-biodegradable substances such as metals derived from energy-intensive processes, while low-carbon materials may include biodegradable substances such as bamboo, natural fiber composites, or sustainably harvested wood.

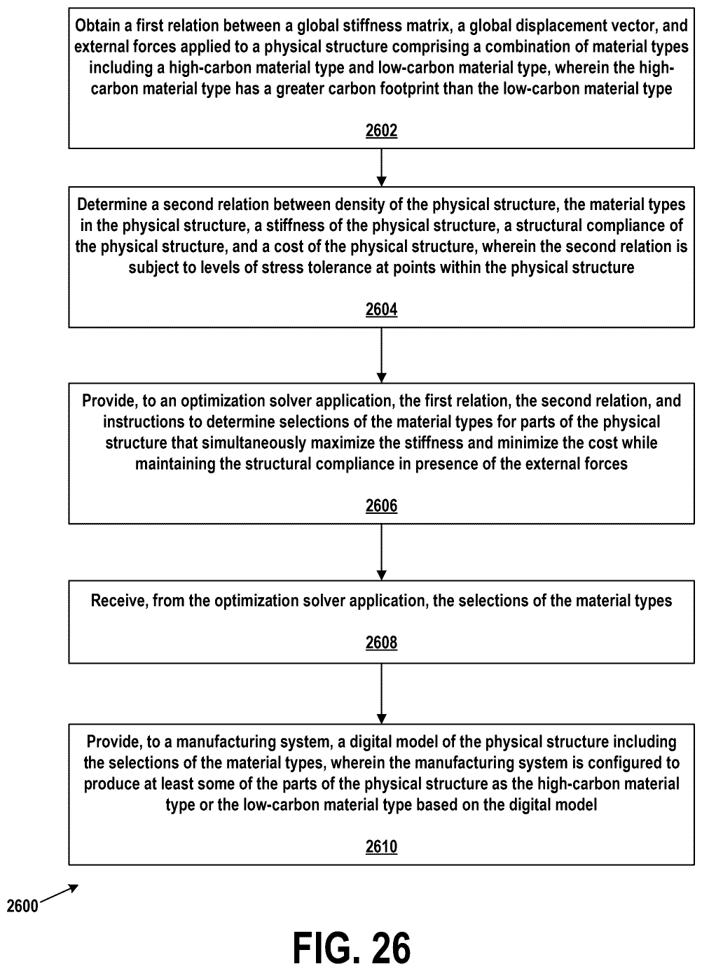

FIG. 26 is a flow chart 2600 illustrating an example embodiment. The process illustrated by FIG. 26 may be carried out by a computing device, such as computing device 100, and/or a cluster of computing devices, such as server cluster 200. However, the process can be carried out by other types of devices or device subsystems.

The embodiments of FIG. 26 may be simplified by the removal of any one or more of the features shown therein. Further, these embodiments may be combined with features, aspects, and/or implementations of any of the previous figures or otherwise described herein.

Block 2602 may involve obtaining a first relation between a global stiffness matrix, a global displacement vector, and external forces applied to a physical structure comprising a combination of material types including a high-carbon material type and low-carbon material type, wherein the high-carbon material type has a greater carbon footprint than the low-carbon material type. Either of the material types can be isotropic or orthotropic/anisotropic in stiffness and strength.

Block 2604 may involve determining a second relation between density of the physical structure, the material types in the physical structure, a stiffness of the physical structure, a structural compliance of the physical structure, and a cost of the physical structure, wherein the second relation is subject to levels of stress tolerance at points within the physical structure.

Block 2606 may involve providing, to an optimization solver application, the first relation, the second relation, and instructions to determine selections of the material types for parts of the physical structure that simultaneously maximize the stiffness and minimize the cost while maintaining the structural compliance in presence of the external forces.

Block 2608 may involve receiving, from the optimization solver application, the selections of the material types.

Block 2610 may involve providing, to a manufacturing system, a digital model of the physical structure including the selections of the material types, wherein the manufacturing system is configured to produce at least some of the parts of the physical structure as the high-carbon material type or the low-carbon material type based on the digital model.

In some embodiments, the second relation is subject to an overall volume constraint of the physical structure.

In some embodiments, the second relation is subject to a constraint on an overall environmental impact of the physical structure, wherein the overall environmental impact of the physical structure is based on use of the high-carbon material type and the low-carbon material type in the physical structure.

In some embodiments, the overall environmental impact of the physical structure is based on linear functions of volumes of the high-carbon material type and the low-carbon material type in the physical structure.

In some embodiments, the high-carbon material type includes one or more of steel, aluminum, or concrete, and wherein the low-carbon material type include one or more of bamboo or timber.

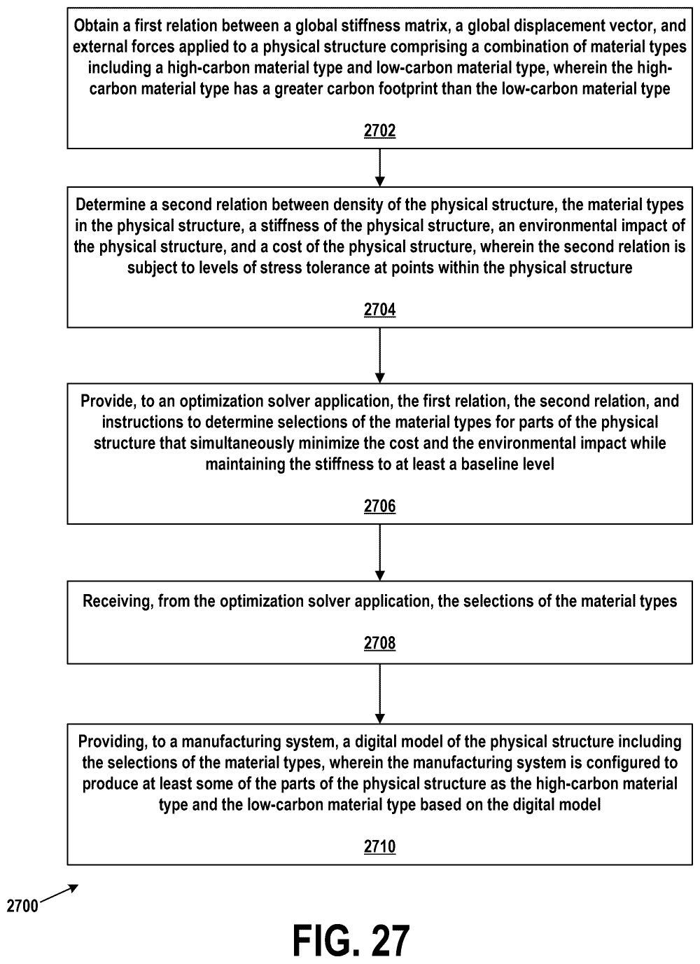

FIG. 27 is a flow chart 2700 illustrating an example embodiment. The process illustrated by FIG. 27 may be carried out by a computing device, such as computing device 100, and/or a cluster of computing devices, such as server cluster 200. However, the process can be carried out by other types of devices or device subsystems.

The embodiments of FIG. 27 may be simplified by the removal of any one or more of the features shown therein. Further, these embodiments may be combined with features, aspects, and/or implementations of any of the previous figures or otherwise described herein.

Block 2702 may involve obtaining a first relation between a global stiffness matrix, a global displacement vector, and external forces applied to a physical structure comprising a combination of material types including a high-carbon material type and low-carbon material type, wherein the high-carbon material type has a greater carbon footprint than the low-carbon material type. Either of the material types can be isotropic or orthotropic/anisotropic in stiffness and strength.

Block 2704 may involve determining a second relation between density of the physical structure, the material types in the physical structure, a stiffness of the physical structure, an environmental impact of the physical structure, and a cost of the physical structure, wherein the second relation is subject to levels of stress tolerance at points within the physical structure.

Block 2706 may involve providing, to an optimization solver application, the first relation, the second relation, and instructions to determine selections of the material types for parts of the physical structure that simultaneously minimize the cost and the environmental impact while maintaining the stiffness to at least a baseline level.

Block 2708 may involve receiving, from the optimization solver application, the selections of the material types.

Block 2710 may involve providing, to a manufacturing system, a digital model of the physical structure including the selections of the material types, wherein the manufacturing system is configured to produce at least some of the parts of the physical structure as the high-carbon material type and the low-carbon material type based on the digital model.

In some embodiments, the second relation is subject to an overall volume constraint of the physical structure.

In some embodiments, the second relation is subject to a constraint on structural compliance of the physical structure, wherein the second relation also maintains the structural compliance in presence of the external forces.

In some embodiments, the high-carbon material type includes one or more of steel, aluminum, or concrete, and wherein the low-carbon material type include one or more of bamboo or timber.

### F. Example Technical Improvements

The integration of advanced manufacturing techniques with a material optimization framework that considers stiffness, stress tolerance, strength, and environmental impact represents a significant technical improvement over conventional construction methods. Traditional design and fabrication workflows typically separate the stages of material selection, structural analysis, and physical manufacturing, often relying on static heuristics or human judgment to choose materials. By contrast, the disclosed system leverages a digital design pipeline where materials are algorithmically assigned to structural regions based on quantified performance metrics. This allows the structure to meet mechanical requirements such as load-bearing capacity and durability while simultaneously minimizing material waste and environmental footprint.

Using additive, subtractive, and/or hybrid manufacturing processes in tandem with this optimization framework enables the fabrication of geometrically complex and functional structures that would be impractical to produce otherwise. For example, high-stress zones can be reinforced with mineral-based components like steel or reinforced concrete, while low-load regions can be filled with biodegradable or renewable materials such as bamboo. This localized material allocation, guided by simulation and optimization algorithms, not only improves structural efficiency and reduces unnecessary mass, but also permits more targeted use of biodegradable materials thereby lowering the overall carbon footprint of the structure. As a result, the combined system improves mechanical performance, resource efficiency, and sustainability in ways not achievable through conventional uniform-material or even multi-material construction.

Other technical improvements may flow from these embodiments. Therefore, this statement of technical improvement is non-limiting.

### IV. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of non-transitory computer readable medium such as a storage device including RAM, ROM, a disk drive, a solid-state drive, or another tangible storage medium.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A computer-implemented method comprising:
obtaining a first relation between a global stiffness matrix, a global displacement vector, and external forces applied to a physical structure comprising one or more types of materials;
determining a second relation between structural geometry of the physical structure, anisotropic and isotropic material phases in the physical structure, a stiffness of the physical structure, and a plurality of densities and volumes for each of the material phases, wherein the second relation is subject to levels of stress tolerance at points within the physical structure;
providing, to an optimization solver application, the first relation, the second relation, and instructions to determine values of the structural geometry and the anisotropic and isotropic material phases that simultaneously maximize the stiffness and minimize the volumes while maintaining the levels of stress tolerance in presence of the external forces;
receiving, from the optimization solver application, the values of the structural geometry and the anisotropic and isotropic material phases; and
providing, to an additive manufacturing system, a digital model of the physical structure including the values of the structural geometry and the anisotropic and isotropic material phases, wherein the additive manufacturing system is configured to employ process-induced anisotropy to print a physical representation of at least part of the physical structure in accordance with the structural geometry and the anisotropic and isotropic material phases.

2. The computer-implemented method of claim 1, further comprising:
printing, by the additive manufacturing system, the physical representation of the physical structure in accordance with the structural geometry and the anisotropic and isotropic material phases while employing the process-induced anisotropy.

3. The computer-implemented method of claim 1, wherein at least one of the anisotropic material phases is printed as multiple layers of material with a fixed infill direction, and at least one of the isotropic material phases is printed by varying infill directions across successive layers.

4. The computer-implemented method of claim 1, wherein at least one of the isotropic material phases is printed by varying infill directions across successive layers by a fixed angle less than 45 degrees.

5. The computer-implemented method of claim 1, wherein the material phases are printed with infill densities from 60% to 80%.

6. The computer-implemented method of claim 1, wherein the physical structure comprises both of the anisotropic and isotropic material phases.

7. The computer-implemented method of claim 1, wherein the optimization solver application is configured to determine the values of the structural geometry and the anisotropic and isotropic material phases using an iterative process, and wherein an iteration of the iterative process comprises:
decomposing the physical structure into a material phase distribution on a finite element mesh;
determining, based on the finite element mesh, the values of the structural geometry and the anisotropic and isotropic material phases that simultaneously maximize the stiffness and minimize the volumes while maintaining the levels of stress tolerance in presence of the external forces; and
based on a gradient between the values of the structural geometry and the anisotropic and isotropic material phases and previous values thereof from previous iterations of the iterative process, determining parameters for a new material phase distribution on the finite element mesh to be used in a subsequent iteration of the iterative process.

8. The computer-implemented method of claim 1, wherein s-shaped interface geometries are used between at least some of the material phases.

9. The computer-implemented method of claim 8, wherein the material phases with the s-shaped interface geometries are printed together.

10. The computer-implemented method of claim 1, wherein the levels of stress tolerance conform with von Mises constraints for the isotropic material phases.

11. The computer-implemented method of claim 1, wherein the levels of stress tolerance conform with von Tsai-Wi constraints for the anisotropic material phases.

12. A computer-implemented method comprising:
obtaining a first relation between a global stiffness matrix, a global displacement vector, and external forces applied to a physical structure comprising a combination of material types including a high-carbon material type and low-carbon material type, wherein the high-carbon material type has a greater carbon footprint than the low-carbon material type;
determining a second relation between density of the physical structure, the material types in the physical structure, a stiffness of the physical structure, a structural compliance of the physical structure, and a cost of the physical structure, wherein the second relation is subject to levels of stress tolerance at points within the physical structure;
providing, to an optimization solver application, the first relation, the second relation, and instructions to determine selections of the material types for parts of the physical structure that simultaneously maximize the stiffness and minimize the cost while maintaining the structural compliance in presence of the external forces;
receiving, from the optimization solver application, the selections of the material types; and
providing, to a manufacturing system, a digital model of the physical structure including the selections of the material types, wherein the manufacturing system is configured to produce at least some of the parts of the physical structure as the high-carbon material type or the low-carbon material type based on the digital model.

13. The computer-implemented method of claim 12, wherein the second relation is subject to an overall volume constraint of the physical structure.

14. The computer-implemented method of claim 12, wherein the second relation is subject to a constraint on an overall environmental impact of the physical structure, wherein the overall environmental impact of the physical structure is based on use of the high-carbon material type and the low-carbon material type in the physical structure.

15. The computer-implemented method of claim 14, wherein the overall environmental impact of the physical structure is based on linear functions of volumes of the high-carbon material type and the low-carbon material type in the physical structure.

16. The computer-implemented method of claim 12, wherein the high-carbon material type includes one or more of steel, aluminum, or concrete, and wherein the low-carbon material type include one or more of bamboo or timber.

17. A computer-implemented method comprising:
obtaining a first relation between a global stiffness matrix, a global displacement vector, and external forces applied to a physical structure comprising a combination of material types including a high-carbon material type and low-carbon material type, wherein the high-carbon material type has a greater carbon footprint than the low-carbon material type;
determining a second relation between density of the physical structure, the material types in the physical structure, a stiffness of the physical structure, an environmental impact of the physical structure, and a cost of the physical structure, wherein the second relation is subject to levels of stress tolerance at points within the physical structure;
providing, to an optimization solver application, the first relation, the second relation, and instructions to determine selections of the material types for parts of the physical structure that simultaneously minimize the cost and the environmental impact while maintaining the stiffness to at least a baseline level;
receiving, from the optimization solver application, the selections of the material types; and
providing, to a manufacturing system, a digital model of the physical structure including the selections of the material types, wherein the manufacturing system is configured to produce at least some of the parts of the physical structure as the high-carbon material type and the low-carbon material type based on the digital model.

18. The computer-implemented method of claim 17, wherein the second relation is subject to an overall volume constraint of the physical structure.

19. The computer-implemented method of claim 17, wherein the second relation is subject to a constraint on structural compliance of the physical structure, wherein the second relation also maintains the structural compliance in presence of the external forces.

20. The computer-implemented method of claim 17, wherein the high-carbon material type includes one or more of steel, aluminum, or concrete, and wherein the low-carbon material type include one or more of bamboo or timber.
